(19) United States
(12) Patent Application Publication
(10) Pub. No.: US 2026/0195304 A1
(43) Pub. Date: Jul. 9, 2026

(54) KNOWLEDGE DRIVEN DATA FORMAT FRAMEWORK

(71) Applicant: AgileDelta, Inc., Redmond, WA (US)

(72) Inventors: John Curtis SCHNEIDER, Redmond, WA (US); Richard Alan ROLLMAN, Redmond, WA (US)

(73) Assignee: AgileDelta, Inc., Redmond, WA (US)

(21) Appl. No.: 18/872,738

(22) PCT Filed: Jun. 23, 2023
(86) PCT No.: PCT/US2023/068970

§ 371 Date: Dec. 6, 2024

Related U.S. Application Data
(60) Provisional application No. 63/355,295, filed on Jun. 24, 2022.

(51) Int. Cl. G06F 16/21; G06F 16/28

(52) U.S. Cl. CPC G06F 16/212; G06F 16/289

(57) ABSTRACT

Various technologies for providing a knowledge-driven data format framework (KDF) are disclosed. The KDF uses a declarative, format-independent description of logical information being stored and/or exchanged by different computing systems to drive reading, writing and translation of information objects to and from different data formats. The KDF uses this description to navigate a logical structure of input information objects, and determines formatting decisions for reading, writing, and/or translating the information objects using one or more format-specific coder/decoder (CODEC). The KDF uses a format-independent, data driven (FIDD) API, FIDD translation elements, and FIDD in-memory data structures for translation of information objects from at least one of a plurality of data formats into another one of the plurality of data formats. As such, there are no mismatches between in-memory data structures, and thus, no coding is required to translate between various ones of the plurality of APIs, parsers, serializers, and data structures.

### RELATED APPLICATIONS

The present application is a US national phase application, which claims priority to PCT Application No. PCT/US2023/068970, filed on Jun. 23, 2023, which claims priority to U.S. Provisional App. No. 63/355,295 filed on Jun. 24, 2022 (“[′295]”), the contents of which are hereby incorporated by reference in their entirety.

### STATEMENT REGARDING FEDERALLY SPONSORED RESEARCH

The present invention was made with government support from the U.S. Department of Defense (DoD), Phase II, Small Business Innovation Research (SBIR), U.S. Navy contract number N00039-07-C-0137. The government may have certain rights in the invention.

### FIELD

The present disclosure relates to the technical field of computing and communication, and in particular, to a knowledge-driven data format framework for format-independent data translation.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

In today's information age, computer systems frequently connect and share data with a wide range of external or remote systems. Computer systems implement a wide range of data formats to store, organize, and exchange data using a wide range of media. Each data format implemented by a computer system requires hardware or software custom developed to parse each data format into in-memory data structures and/or serialize in-memory data structures into each data format. This interfacing software can be tedious and time consuming to develop. It can comprise a significant portion of the overall system and contribute significantly to its development effort, cost and time. This can be particularly pronounced in systems with high performance requirements and/or limited resources that require more complex, packed binary formats to achieve their performance and/or resource utilization requirements.

Although data format coding strategies and methods may not change much over time, the logical information represented by the data format often changes relatively frequently to support new and changing information exchange and data storage requirements. Maintaining an independent set of data format processors as information exchange and storage requirements change can require a significant ongoing investment in time and resources.

Many systems migrate to newer, more modern data formats or to open standard data formats to increase capability, interoperability, efficiency, and/or affordability. When these systems migrate to these newer data formats, new parsers, serializers, and in-memory data structures must be implemented to represent logical information. In addition to implementing the new data formats, many newer systems require the capability to translate between older data formats and the newer data formats to maintain backward compatibility with systems that are still using the older data formats. Maintaining these translators as older and newer data formats evolve independently can become time consuming and costly(e.g., in terms of labor and/or resource consumption) as they need to translate between all the different versions of the different formats at any given point in time.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings, which include:

FIG. 1 illustrates an arrangement suitable for practicing various aspects of the present disclosure; FIG. 2 illustrates an example Knowledge-driven Data format Framework (KDF);

FIG. 3 illustrates example logical interactions between elements of the KDF of FIG. 2; FIG. 4 illustrates example deterministic finite automata; FIG. 5 shows an example process for providing a KDF; FIG. 6 shows a process for reading an information object (InOb); FIG. 7 shows a process for writing an InOb; and FIG. 8 illustrates an example computing system suitable for practicing various aspects of the present disclosure.

### DETAILED DESCRIPTION

### 1. Knowledge-Driven Data Format Framework Systems and Configurations

The present disclosure provides a knowledge-driven data format framework that uses a declarative, format-independent description of the logical information being exchanged or stored to drive parsing, serialization and translation of data. The format independent parsing and serializing can be combined to accomplish data translation. The format independent parsing and serializing can also be used separately by an application to read and write data formats outside the context of translation. A universal data-driven parser and a universal data-driven serializer use this description of received data to navigate the logical information in a data format and determine the set of physical formatting decisions that need to be made to fully parse, serialize, and translate a physical representation of the data format. The universal data-driven parser and/or the universal data-driven serializer delegate these decisions to a format-specific coder/decoder (CODEC) that requires far less time and skill to develop than a complete data format parser, serializer, and/or translator. Once the fundamental data format coding strategies and methods have been specified in the CODEC, changes to the logical data exchanged or stored by the data format can be implemented by updating a declarative, format-independent description of the logical data format. The knowledge-driven data format framework uses the same shared interface definition language (IDL) or schema, shared parser, shared serializer, and shared in-memory data structures for transformation of all data formats. As such, there are no mismatches between in-memory data structures, and therefore, no coding is required to translate between them.

Conventional data transformation systems often use separate, custom developed parsers and serializers for each data format they implement. Although these custom parsers and serializers transform data formats by employing different combinations of data coding strategies, such systems do not generally share any common software components. Therefore, there is a large amount of duplicated functionality across these solutions, and each custom parser and serializer must be separately updated and tested to meet updated/newer logical data exchange and storage requirements. Updating custom parsers/serializers for custom data formats may be difficult, such as when there are only relatively few or no developers who understand the data format and/or the parsing and serialization program code, and/or when the program code is not written in a manner that is easily updated to accommodate changing requirements. Moreover, individual parsers and serializers generally use different in-memory data structures to represent the data, making translation between different data formats relatively complex. For instance, translating between n number of different formats can require n2 number of functions to be written for moving data between each pair of mismatched in-memory representations.

As alluded to previously, the development of separate, custom developed parsers and serializers for individual data formats is time consuming and requires duplication component functionality across these implementations, which is inefficient in terms of computational and storage/memory resources. Updates to the conventional data transformation systems are also costly in terms of development time and resource consumption. Moreover, translating between data formats using these conventional systems is also computationally intensive due to the mismatches between in-memory data structures of each data format.

Some conventional data parsing, serialization and transformation systems include data formats that use a declarative IDL or schema language to describe the logical information represented by the data format and specify the coding strategy used to represent each data item. For example, an IDL may specify that a logical data item for a person's name is represented using the format's “string” data type, and the format specification may indicate that all strings are physically represented as a length-prefixed sequence of UTF-8 encoded characters with the length itself is represented as a 16-bit unsigned integer using little-endian bit order. These IDLs and schema languages are useful for reducing the amount of effort required to specify the logical information and physical encoding for the data. However, each data format still requires its own IDL and its own IDL compiler to be defined. Additionally, each data format still requires its own parser and serializer, as well as its own in-memory data structures to represent the data. Therefore, changes to the logical information a system processes may require changes to several different IDLs and different sets of interfacing software, and adding new formats may require a completely new set of IDLs, parsers, serializers and data structures. Moreover, translating between these data formats still requires n² functions to map between n different in-memory data structures. Therefore, systems implementing data formats that use an IDL to specify the logical format of the messages can reduce the amount of effort required to specify and change messages, however, these systems still suffer from the drawbacks discussed previously.

There have also been some more expressive IDLs or schema languages developed that can specify a wider range of coding strategies, and therefore, a wider range of data formats. Some Data transformation systems using these methods allow a single IDL to specify a set of simple data formats. However, these methods only work for a subset of data formats that can be fully specified declaratively at development time using a limited set of pre-defined coding strategies. These methods do not work for formats that use specially optimized or otherwise uncommon coding strategies. Additionally, these methods do not generally work for coding strategies that change dynamically based on the data being encoded or require algorithmic computation of certain fields. For example, even a simple length field in a header that indicates the total number of bytes in the data format or checksum field for verifying data integrity might not be possible because they must be computed dynamically based on data that is not available at IDL development time. Even when these methods do work, they still require a separate IDL or schema be created for each data format, and when logical formats change, those changes must duplicated across all of the IDLs and/or schemas separately. Therefore, systems implementing these more expressive IDLs/schema languages still suffer from the drawbacks discussed previously.

In contrast to the conventional solutions discussed previously, the knowledge-driven data format framework of the present disclosure dramatically reduces the amount of time, effort, resources, and costs required to implement, maintain, and translate between different data formats. The universal parser and universal serializer handle most of the complexity involved in parsing and serializing data formats, which allows new(e.g., to-be-developed) data formats to be implemented faster than previously possible by developing a CODEC that specifies the coding strategies for encoding and/or arranging different data elements or different kinds of data. Additionally, new messages and changes to existing messages can be implemented quickly by updating a format-independent IDL or schema. The embodiments discussed herein also improve the performance of computing systems/devices in that little to no code is required for translating between different in-memory data structures. These and other aspects are discussed with reference to the accompanying figures. It should be noted that the previous description and the following described example implementation(s) are only presented by way of example and should not be construed as limiting the inventive concepts to any particular physical configuration or arrangement.

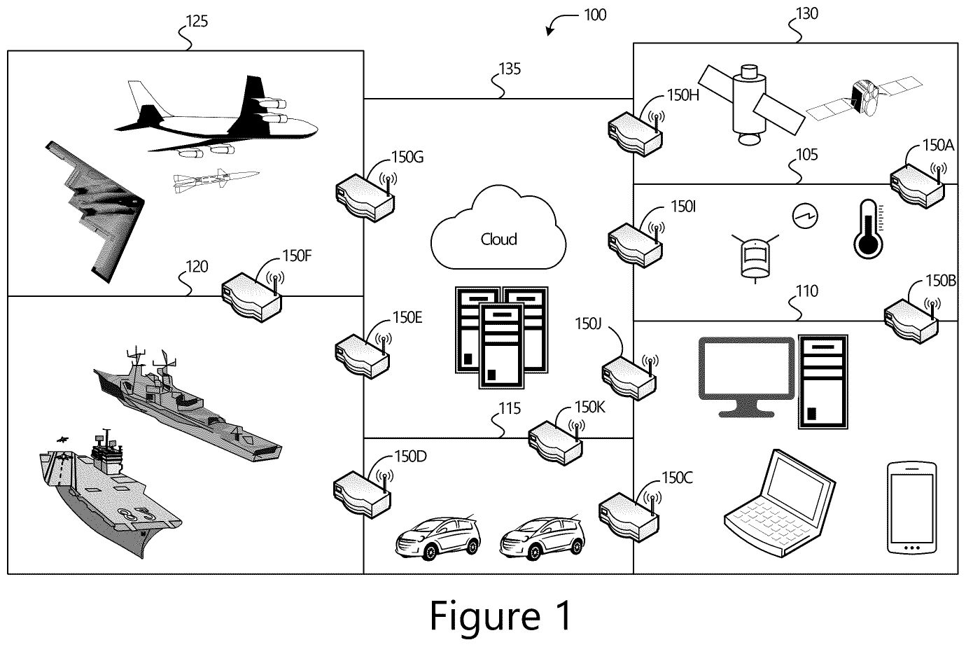

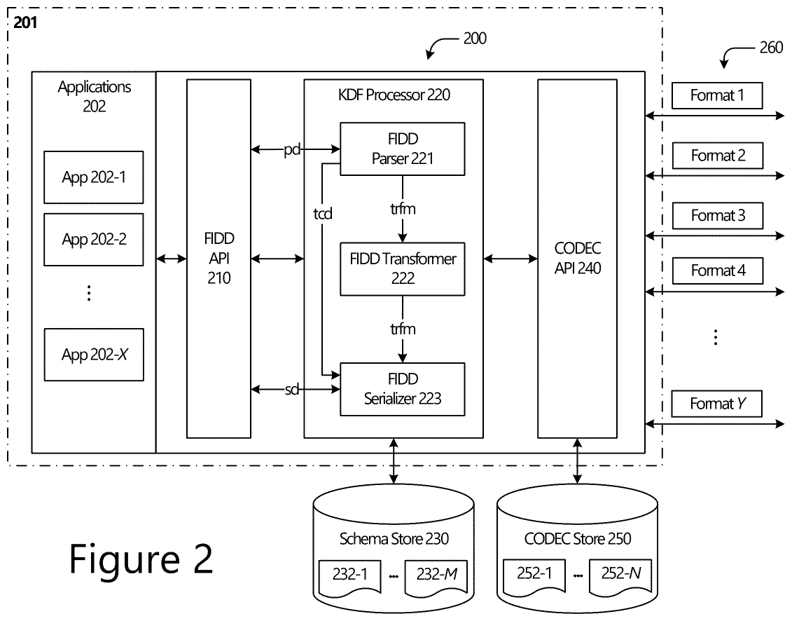

Referring now to FIG. 1, which shows an example arrangement 100 suitable for practicing various aspects of the present disclosure. As shown in FIG. 1, example arrangement 100 includes Internet of Things(IoT) devices 105, a user systems 110 (also referred to as “client devices”, “client systems”, or the like), vehicle systems 115, marine systems 120, aerial systems 125, satellite systems 130, service providers 135, and a plurality of gateway(GW) appliances 150A-I(collectively referred to as a “GW 150” or “GWs 150”). For purposes of the present disclosure, each of the systems/devices depicts by FIG. 1 may be collectively referred to as “systems 105-135” or the like. Further, in alternate implementations, like arrangements may have more or less of the various types of devices/systems.

Each of the systems 105-135 and GW 150 include physical hardware elements and software components capable of executing one or more applications(apps) and accessing content and/or services provided by the other systems 105-135 and/or GW 150. The systems 105-135 and GWs 150 communicate with one another using suitable communication protocol(s), for example, Hypertext Transfer Protocol(HTTP) over Transmission Control Protocol (TCP)/Internet Protocol(IP), or one or more other protocols such as Extensible Messaging and Presence Protocol(XMPP); File Transfer Protocol(FTP); Secure Shell(SSH); Session Initiation Protocol(SIP) with Session Description Protocol(SDP), Real-time Transport Protocol(RTP), Secure RTP(SRTP), Real-time Streaming Protocol(RTSP), or the like; Simple Network Management Protocol(SNMP); WebSocket; Wireless Application Messaging Protocol(WAMP); Joint Range Extension Applications Protocol(JREAP) A, B, and C; User Datagram Protocol (UDP); QUIC(sometimes referred to as “Quick UDP Internet Connections”); Remote Direct Memory Access(RDMA); Stream Control Transmission Protocol(SCTP); Internet Control Message Protocol(ICMP); Internet Group Management Protocol(IGMP); Internet Protocol Security(IPsec); Military Standard(MTD-STD) 1553, MTD-STD-1773; X.25; a suitable Tactical Data Link(TDL) such as Multifuction Advanced Data Link(MADL), Link 16, Link 22, Enhanced Position Location Reporting System(EPLRS), Situation Awareness Data Link(SADL), and/or the like; SpaceWire (see e.g., SpaceWire-Links, nodes, routers and networks, EUROPEAN COOPERATION FOR SPACE STANDARDIZATION(ECSS), ECSS-E-ST-50-12C, Rev. 1, (15 May 2019)); MIL-STD-1553; and/or any other communication protocols and/or access technologies, such as any of those discussed herein, any of those discussed in [′295], and/or those not explicitly described herein.

The IoT devices 105 are uniquely identifiable embedded computing devices that comprise a network access technology designed for low-power apps utilizing short-lived links/connections. The IoT devices 105 may capture and record data associated with an event, and communicate such data with one or more other devices over a network with little or no user intervention. As examples, IoT devices 105 may be (or may include) autonomous sensors, gauges, meters, image capture devices, microphones, light emitting devices, audio emitting devices, audio and/or video playback devices, electro-mechanical devices (e.g., switch, actuator, and/or the like), microcontrollers, control modules, networked or “smart” appliances, MTC devices, M2M devices, and/or the like.

The user systems 110 can be implemented as any suitable computing system or other data processing apparatus usable by users to access content/services provided by the service providers 135 and/or other systems 110-125. Examples of the user systems 110 include desktop computers, workstations, laptops, mobile phones (e.g., a “smartphone”), tablet computers, portable media players, wearable computing devices, handheld transceivers(also referred to as “walkie-talkies”), or other computing devices/systems capable of interfacing directly or indirectly with network infrastructure or other systems 110-135.

Vehicle systems 115 may be any type of motorized vehicles equipped with controls used for driving, parking, passenger comfort and/or safety, military apps, and/or the like. The motors of the vehicles may include any devices/apparatuses that convert one form of energy into mechanical energy, including internal combustion engines (ICE), compression combustion engines (CCE), electric motors, hybrids(e.g., including an ICE/CCE and electric motor(s)), hydrogen fuel cells, and the like. Vehicle systems 115 may be, or may include, embedded devices that monitor and control various subsystems of the vehicle systems 115. Examples of the vehicle systems 115 may be considered synonymous to, and may include any type of computer device used to control one or more systems of a vehicle, such as an electronic/engine control unit, electronic/engine control module, embedded system, microcontroller, control module, engine management system(EMS), onboard diagnostic(OBD) devices, dashtop mobile equipment (DME), mobile data terminals(MDTs), in-vehicle infotainment system, and/or the like. Marine systems 120 refer to computing system(s) disposed in or otherwise implemented by a watercraft such as, for example, merchant watercraft, naval watercraft(e.g., surface warships, submarines, aircraft carriers, auxiliary ships, and/or the like), special-purpose vessels (e.g., weather ships, research vessels, and/or the like), and the like. Examples of the marine systems 120 may include inertial navigation systems(INS), radio navigation systems or radio direction finders, radar systems(e.g., Automatic Radar Plotting Aid(ARPA)), satellite navigation systems or GNSS positioning systems, Electronic Chart Display Information Systems(ECDIS), Long Range Tracking and Identification(LRIT) systems, integrated bridge systems, and/or the like.

Aerial systems 125 include computing systems implemented in flying objects, such as aircraft, drones, unmanned aerial vehicles (UAVs), missiles and/or missile defense systems, and/or to any other like aerial systems/devices. Examples of the aerial systems 125 may include flight management systems(FMS), INS, electronic flight instruments, cockpit display systems (CDS), head-up display(HUD) systems, an Integrated Modular Avionics(IMA) systems, and/or the like.

Satellite systems 130 may include systems that use satellites to provide navigation or geo-spatial positioning services, communication services, observation or surveillance services, weather monitoring services, and/or the like, to other systems 105-125, 135 and/or GWs 150. The satellite systems 130 may include one or more terrestrial stations and one or more satellites that communicate with one another via respective links.

The service providers 135 includes one or more physical and/or virtualized systems for providing content and/or functionality(i.e., services) to one or more clients(e.g., any of systems 105-130) over a network. The physical and/or virtualized systems include one or more logically or physically connected servers and/or data storage devices distributed locally or across one or more geographic locations. Generally, the service providers 135 is configured to use IP/network resources to provide web pages, forms, apps, data, services, and/or media content to systems 105-130. As examples, the service providers 135 may provide cloud computing services, database (DB) services (e.g., mutli-tenancy and/or on-demand DB services), geographic/geometric and/or(navigational) mapping services, search engine services, social networking and/or microblogging services, content(media) streaming services, e-commerce services, cloud analytics services, immersive gaming experiences, and/or other like services. In some implementations, the service providers 135 may provide on-demand database services, web-based customer relationship management(CRM) services, or the like. In some implementations, the service providers 135 may also be configured to support communication services such as Voice-over-Internet Protocol(VoIP) sessions, PTT sessions, group communication sessions, and the like for the systems 105-130.

Additionally or alternatively, the service provider 135 may represent a command center, control center, an Incident Command Post(ICP) or Incident Command System(ICS), dispatch center, and/or some other combination of facilities, equipment, personnel, and communications operating to provide centralized command for some purpose (s)(e.g., data center management, business application management, civil/civilian operational management, emergency/crisis management, and/or the like), and which may be operated by a government agency, a private enterprise, or a combination thereof. In these examples, the command center may include various ground equipment such as a network of radio transceivers managed by a central site computer or centralized computer network, which handles and routes messages between the various systems 105-130. In some implementations, the communication capabilities/functions may be contracted out to a datalink service provider (DSP) and/or to one or more separate service providers. For example, the command center can include a directional antenna, which may be a high gain, long distance datalink anetanna(e.g., a satellite dish (es) and/or the like) for communicating with the aircraft 125 and/or other systems 105-130, including via one or more GWs 150.

The GWs 150 (sometimes referred to as “Interoperability Gateway”, “Efficient Data Gateway”, “Edge Gateway”, or the like) are network appliances or other like hardware elements that control the flow of data from one network to another network or from one system to another system. The GWs 150 may also be computing systems or apps configured to perform the tasks of a gateway. Examples of GWs 150 may include IP gateways, Internet-to-Orbit(120) gateways, IoT gateways, cloud storage gateways, TDL gateways, and/or the like.

In many scenarios, the systems 105-135 may need to exchange information objects (InObs) with one another. Each of these InObs may be represented using one of a plurality of data formats. However, in some cases, different systems 105-135 may be configured to consume and/or produce InObs using different data formats. Conventionally, sharing InObs between among the various systems 105-135 over the (global) network would require the use of the GWs 150, which provide data translation services for the different systems 105-135. As an example, the arrangement 100 may be a Multi-Tactical Data Link Network (MTN) wherein the aerial systems 125 utilize the Link 16 format and the service providers 135 utilize XML. In this example, the GW 150G translates InObs produced by aerial systems 125 in the Link 16 format into XML for consumption by the service providers 135, and translates InObs produced by service providers 135 in XML format into Link 16 format for consumption by the aerial systems 125.

As enterprises, service provider platforms, and/or other like organizations shift toward network-centric operations, sharing common InObs between various systems 105-135 over a (global) network increasingly becomes complex as newer versions of systems 105-135 use newer data formats to share InObs than older versions of systems 105-135. One challenge to sharing common InObs involves bridging the gap between systems 105-135 that share information using newer, more up-to-date data formats(e.g., XML, EXI, JSON, Protobuf, and/or the like) and systems 105-135 that require different data formats to represent InObs(e.g., TDL data formats). Although data formats may not change much over time, the logical information represented by the data format often changes relatively frequently to support new and changing information exchange and data storage requirements.

In various examples, individuals systems 105-135 and/or GWs 150 may implement respective instances/aspects of a knowledge-driven data format framework (e.g., knowledge-driven data format framework (KDF) 200 of FIG. 2) to connect with and share InObs(and/or data) with a wide range of external systems 105-135 using a variety of data formats. In some implementations, the GWs 150 implement the KDF and continue to provide the data translation services. In other implementations, each of the systems 105-135 implement their own version of the KDF and perform data translation functions themselves. While specific configurations and arrangements of the systems 105-135 have been described, it should be understood that the inventive concepts can be applied to a wide variety of components, devices, systems, and/or other elements, including those not explicitly discussed herein.

For purposes of the present disclosure, the concept of “data translation” (or simply “translation”) includes two different types of translation: transcoding and transformation. “Transcoding” involves taking logical information/data expressed in one physical format(e.g., a packed binary format) and translating the same logical information/data into another physical format(e.g., XML, EXI, or the like) in the same sequence. In other words, transcoding involves taking the same information in the same sequence and packing the information(e.g., bits or bytes) differently. “Transformation” is the process of converting data from a first logical data structure into a second logical data structure, and involves reshaping the data into the second logical data structure to conform with a different logical schema and according to a transformation specification. The transformation specification indicates how to extract data out of the first logical data structure and also indicates how to transform it into a completely different logical data structure (e.g., the second formation). Stated another way, transformation involves going from one schema to another schema. A common example of data transformation includes using one or more extensible Stylesheet Language Transformations(XSLT) stylesheets to transform data in one or more XML documents into an HTML document that a web browser can render. In this example, the XSLT stylesheets are the transformation specification that, for XSLT, define how to handle different nodes if/when encountered and how to generate a result tree data structure from the encountered nodes (where the result tree is the basis for the output document).

In various examples, the translation services provided by the KDF (e.g., KDF 200 of FIG. 2) may involve one or both types of translation(e.g., transcoding only, transformation only, or both transcoding and transformation). Additionally or alternatively, the KDF translates an InOb having a first logical and physical organization of data(which may have been developed by a particular standards community for a particular purpose) into a different InOb having a second logical and physical organization of data different than the first organization of data(and which may have been developed by a different standards community for a same or different purpose) so as to achieve interoperability between the InObs and/or standards. In other words, the KDF translates between two different data formats and/or translates between two different schemas, where a data format and a schema define a logical and physical organization of data in a particular InOb. In these ways, the KDF bridges a gap between two formats that were not originally designed to work together.

The KDF aspects discussed herein alleviate the need to maintain separate, custom developed parsers and serializers to transform data in a specific data formats into another specific data format, which requires less labor and fewer hardware and software resources. In this way, the data transformation provided by the knowledge-driven data format framework provides interoperability between various systems 105-135 using less labor and fewer computational resources than existing solutions. “Interoperability” refers to the ability of various systems 105-135 utilizing one type of data format to exchange data with systems 105-135 utilizing one or more other types of data formats. Aspects of these examples are discussed in more detail with respect to FIGS. 2-7.

Referring now to FIG. 2, which illustrates an example Knowledge-driven Data format Framework (KDF) 200. In this example, the KDF 200 is implemented by an example compute node 201, which may correspond to one of the systems 105-135 or GWs 150 of FIG. 1. As shown, the KDF 200 includes one or more applications(apps) 202, a Format-Independent Data Driven (FIDD) API 210, an KDF processor 220, a schema store 230, a codec API 240, a codec store 250, and a plurality of data formats 260. The KDF processor 220 includes an FIDD parser 221, FIDD transformer 222, and FIDD serializer 223. For purposes of the present disclosure, the term “format-independent” used to describe the FIDD API 210 and FIDD parser 221, FIDD transformer 222, and FIDD serializer 223 indicates that these elements process data and/or objects regardless of the physical format or logical arrangement of those data/objects.

The compute node 201 is configured to run, execute, or otherwise operate one or more apps 202 (including apps 202-1, 202-2, . . . , 202-X where X is a number). The app(s) 202 are (or include) collections of program code, software components, modules, engines, agents, and/or the like. designed to perform tasks, functions, and the like. The app(s) 202 may be developed using any suitable programming languages and/or development tools, such as those discussed herein or others known in the art. In one example, an app 202 may be a client app(client), which may be used to generate, manipulate, and/or render InObs for display. The particular structure or arrangement of data elements of an InOb is defined by a data format 260. The client may be a web browser (or simply a “browser”) for sending and receiving HTTP and/or TDL messages to and from web servers, app servers, other systems 105-135, GWs 150, and/or the like. Example browsers include WebKit-based browsers, Microsoft® Internet Explorer, Microsoft® Edge, Apple® Safari, Google® Chrome, Opera@ browser, Mozilla Firefox, and/or the like. In another example, the client may be a desktop or mobile app that runs directly on the compute node 201 without a browser, which communicates (sends and receives) suitable messages with the other systems 105-135, GWs 150, and/or the like. The header sections of these messages include various operating parameters and the body section of the messages include data, program code, documents, and/or the like. to be consume, executed and/or rendered within the client. The client of either of these examples renders InObs for display within a container or window, execute scripts or program code in the InObs, and/or perform other functions. Additionally, the client may interact with communications interface (s) of the compute node 201 to establish communication sessions which send and receive, for example, HTTP or TDL messages to/from other systems 105-135, GWs 150, and/or the like, send and receive HTTP or TDL messages to/from the other systems, and/or perform(or request performance) of other like functions. Additionally or alternatively, the app(s) 202 may include apps that complement the KDF 200 in service of other apps 202 on other computing nodes 201. In various implementations, one or more of the apps 202 may be custom apps that may be developed by an owner/operator of the compute node 201.

The InObs may include electronic documents, database objects, data structures, files, resources, and/or other like elements that include one or more data items. each of which includes one or more data values. The term “data item” as used herein refers to an atomic state of a particular object with at least one specific property at a certain point in time. Such an object is usually identified by an object name or object identifier, and properties of such an object are usually defined as database objects(e.g., fields, records, and/or the like), object instances, or data elements(e.g., mark-up language elements/tags, and/or the like). The terms “data item” or “information item” as used herein may also refer to data elements and/or content items, although these terms may refer to different concepts. A data element(or simply “element”) is a logical component of an InOb(e.g., an electronic document). In some implementations, an element can be used as a physical representation of a set of other data elements, and can be represented in any physical data format, such as any of those discussed herein, any of those discussed in [′295], and/or those not explicitly described herein. In some implementations, a data element begins with a start tag (e.g., “<element>”) and ends with a matching end tag (e.g., “</element>”), or only an empty element tag (e.g., “<element/>”). In these implementations, any characters between the start tag and end tag, if any, are the element's content(referred to herein as “content items” or the like). Content items may include text content(e.g., “<element>content item</element>”), attributes (e.g., “<element attribute=” attributeValue “>”), and other elements referred to as “child elements” (e.g., “<element1><element2>content item</element2></element1>”). An “attribute” may refer to a markup construct including a name-value pair that exists within a start tag or empty element tag. Attributes contain data related to its element and/or control the element's behavior. In XML-based implementations, each XML document contains one or more elements(also referred to herein as “XML elements”), the boundaries of which can be delimited by start tags and end tags, or by an empty element tag for empty elements. Each XML element has a type, identified by name (referred to as a generic identifier (GI)), and may have a set of attribute specifications. Each attribute specification has a name and a value. Additional aspects of XML and XML elements are discussed in Extensible Markup Language (XML) 1.0, W3C Recommendation, 5th Ed. (26 Nov. 2008), https://www.w3.org/TR/xml/(“[XML]”), the contents of which are hereby incorporated by reference in its entirety and for all purposes.

Additionally or alternatively, InObs may be processed in a streaming fashion, or without constructing a complete logical data structure in memory. The term “stream” or “streaming” refers to a manner of processing in which an InOb does not need to be represented by a complete logical data structure of nodes occupying memory proportional to a size of that InOb, but are processed “on the fly” as a sequence of events. In this context, the term “logical data structure,” “logical structure,” or the like may be any organization or collection of data values and/or data elements, the relationships among the data values/elements, and/or the functions or operations that can be applied to the data values/elements provided. A “logical data structure” may be an aggregate, tree (e.g., abstract syntax tree or the like), graph (e.g., a directed acyclic graph (DAG)), finite automaton, finite state machine (FSM), or other like data structure. As discussed in more detail below, in various embodiments, the logical data structures or data streams are generated by the FIDD parser 221 and/or FIDD serializer 223 of the KDF processor 220.

As alluded to previously, each of the data formats 260 may define the content, data, and/or data items for storing and/or communicating InObs. Each of the data formats 260 may also define the language, syntax, vocabulary, and/or protocols that govern information storage and/or exchange. In some embodiments, one or more data formats 260 may be TDL formats including, for example, J-series message format for Link 16; JREAP messages; MADL, Integrated Broadcast Service/Common Message Format(IBS/CMF), Over-the-Horizon Targeting Gold (OTH-T Gold), Variable Message Format(VMF), United States Message Text Format(USMTF), and any future advanced TDL formats. Additionally or alternatively, the data formats 260 may include, for example, Abstract Syntax Notation One (ASN.1), Bencode, BSON, comma-separated values (CSV), Control Information Exchange Data Model(C2IEDM), DARPA Agent Markup Language (DAML), Document Type Definition(DTD), Electronic Data Interchange (EDI), Extensible Data Notation(EDN), Extensible Markup Language (XML)(see e.g., [XML]), Efficient XML Interchange (EXI)(see e.g., Efficient XML Interchange (EXI) Format 1, W3C Recommendation, 2^{nd} Ed. (11 Feb. 2014), http://www.w3.org/TR/exi/(“[EXI]”), the contents of which are hereby incorporated by reference in its entirety and for all purposes), Extensible Stylesheet Language (XSL), Free Text(FT), Fixed Word Format(FWF), Cisco® Etch, Franca, Geography Markup Language (GML), Java Script Object Notion(JSON), MessagePack™, Open Service Interface Definition, Google® Protocol Buffers(protobuf), Regular Language for XML Next Generation(RelaxNG) schema language, Resource Description Framework (RDF) schema language, RESTful Service Description Language (RSDL), Schematron, Web Application Description Language (WADL), Web Ontology Language (OWL), Web Services Description Language (WSDL), XPath, XQuery, XML Schema Definition(XSD), XML Schema Language, XSL Transformations(XSLT), YAML, Apache® Thrift, and/or the like.

The schema data store 230 is arranged to store one or more logical information schemas 232 (or simply “schemas 232”), such as schemas 232-1 to 232-M(where M is a number). In various embodiments, the schema store 230 may be one or more files stored on one or more disks that is/are loaded into memory at runtime. In these embodiments, the schemas 232 are retrievable from the schema store 230 using a file system path.

Each schema 232 provides a declarative description of the logical data structures represented by a corresponding data format 260. Each schema 232 may specify portions of a source InOb(SIO) in a corresponding source format 260 that should be extracted and manipulated to produce a logical data structure, as well as the output to produce for each extracted/manipulated portion of the SIO. The schemas 232 may describe the constraints on the structure and/or content of a particular data format 260. The constraints are rules governing the order of data items; data types governing the types and number of elements, content, attributes, and/or the like; predicates that must be satisfied, uniqueness rules, referential integrity rules; functions, formulas, equations, algorithms, methods, and/or the like, used to calculate a data value (e.g., “value constraints”); constraints used for determining whether an optional data item is actually present or not and/or used for selecting a data item among a set of mutually exclusive data items(referred to as “conditional constraints”); and/or other like rules or constraints. The declarative description may include a description of the sequencing, grouping, nesting, and/or cardinality of the data items that may occur in a corresponding data format 260. The schemas 232 may also describe the logical range of values that may be represented by one or more of the data items. In some embodiments, the schemas 232 may include annotations to augment the expressive power of the particular language used to implement the schemas 232. In these embodiments, the annotations are used to pass additional information to a codec 252 to assist in processing data items. The schemas 232 may be expressed using a suitable schema language, interface description language (IDL), markup language, grammar, and/or any other language capable of describing the logical structure and content of the data formats 260, such as any of the languages discussed herein. In one example, the schemas 232 are specified using the XML Schema Language.

In various embodiments, the schemas 232 include a set of schema components. The schema components include type definitions(e.g., simple and complex types) and element and attribute declarations. The schema components are used to assess the validity of data items in an InOb for a particular data format 260. Validation is the process of determining whether an InOb, or individual data item, obeys the constraints expressed in a schema 232. A valid InOb or valid document is an InOb whose contents(e.g., data items) obey the constraints expressed in a particular schema 232. The term “assessment” refers to a process of validating an InOb. During assessment, some or all of the data items in the source InOb are associated with declarations and/or type definitions, which are then used in the assessment of those data items in a recursive process.

The KDF processor 220 is a program, app, module, engine, compiler, software package, or other like software element that performs data parsing, serialization and translation, which may involve transcoding and/or transformation. In some implementations, the KDF processor 220 may be referred to as a “KDF translator 220”, “FIDD translator 220,” “FIDD processor 220,” or simply as “translator 220” or “processor 220.” It should be noted that when referred to as a “processor 220” or the like, the “processor 220” is different than hardware processors(e.g., processor circuitry 802 of FIG. 8), which is a collection of hardware elements configured or configurable to execute program code including program code of the processor 220. The term “processor” in the term “KDF processor 220” or the like, as used in the data translation arts, refers to a software element that translates (e.g., transcodes and/or transforms) a source data object into a destination data object.

The processor 220 may be configured with a schema 232 for the data format 260 of the SIO(referred to as a “source format 260”), which provides the processor 220 with an understanding of the logical structure and content of the SIO. Additionally, the processor 220 may be configured with a schema 232 for the data format 260 of the DIO(referred to as a “destination format 260”), which provides the processor 220 with an understanding of the logical structure and content of the DIO. The processor 220 uses this understanding to navigate the logical structure of the source and destination formats 260, and delegate the details of the physical representation of individual source and destination formats 260 to one or more format-specific codecs 252 through the codec API 240. The processor 220 communicates the logical information read or written from specific data formats 260 to a host app 202 via the FIDD API 210. Apps 202 use the FIDD API 210 to access the services of the processor 220. In some cases, an app 202 can use the FIDD API 210 to provide the SIO(e.g., as a stream or file) to the processor 220, and also receive the resulting DIO from the FIDD processor 220 via the FIDD API 210.

As shown by FIG. 2, the processor 220 includes an FIDD parser 221 (or simply “parser 221”) connected to an FIDD transformer 222 (or simply “transformer 222”), which is connected to an FIDD serializer 223 (or simply “serializer 223”). Between reading the data in the SIO(e.g., by the parser 221) and writing the data in the DIO(e.g., by the serializer 223), the transformer 222 can do some manipulation of the data along the way and change the shape of the data. In these cases, the data may travel along the transformation(trfm) path in FIG. 2. The transformation involves rearranging the data items, which may involve changing the order, sequence, and/or nesting of the data items(e.g., changing the schema of the data object). Transcoding may be performed by routing the data directly from the parser 221 to the serializer 223 without utilizing the transformer 222. In these cases, the data may travel along the transcode (tcd) path in FIG. 2. Additionally or alternatively, data may be forwarded by the transformer 222 to the serializer 223 unchanged for transcoding operations(e.g., travel along the trfm path in FIG. 2). The transcoding does not involve rearranging the data, but instead involves changing the data from one format and writing it in another format, keeping the same logical order, sequence, and nesting of the data items. In some embodiments, the format independent parsing and serializing (e.g., the functionality of parser 221 and serializer 223) can be combined to accomplish the translation. In some embodiments, the parser 221 and serializer 223 can be used separately(or individually) by a host app 202 to read and write data formats outside the context of translation, which may include, for example, parsing and/or serializing data. In various implementations, the communication between apps 202 and the parser 221, transformer 222, and serializer 223, or among the parser 221, transformer 222, and serializer 223, may take place using the FIDD API 210. In the example of FIG. 2, the FIDD API 210 includes a first interface that allows the parser 221 to send parsed data(pd) directly to the FIDD API 210 (or the parser 221 can send pd to one or more apps 202 via the FIDD API 210) and a second interface that allows serialized data (sd) to be sent directly to the serializer 223 (or one or more apps 202 can send sd to the serializer 223 via the FIDD API 210). Additionally or alternatively, the FIDD API 210 can include a third interface allowing for data to be communicated directly to the transformer 222.

In some embodiments, KDF processor 220 converts an SIO into a universal or format-independent in-memory structure (referred to herein as a “format-independent logical structure” or “FILS”) using a schema 232 and/or codec 252 associated with the source format 260. In these embodiments, the KDF processor 220 transforms the FILS into a destination InOb(DIO) using a schema 232 and/or codec 252 associated with the destination format 260. In these embodiments, the processor 220 (or transformer 222) configures the parser 221 with an appropriate schema 232 and/or codec 252 for reading and parsing the SIO, and also configures the serializer 223 with an appropriate schema 232 and/or codec 252 for serializing and writing the DIO. For transformation, the parser 221 reads the SIO in the source format 260, and converts it into a FILS having a first schema format(“FILS_s1”), which is a specific format-independent arrangement of data items. The transformer 222 obtains the FILS from the parser 221 and rearranges the FILS_s1 into another schema format(e.g., a FILS having a second format, or “FILS_s2”). Here, the FILS_s2 is still in a format independent form. The FILS_s2 is then provided to the serializer 223, which serializes and/or writes the FILS_s2 into the destination format 260. For transcoding, the parser 221 reads the SIO in the source format 260, and converts it into a FILS having a format independent schema format. Then, the parser 221 sends the FILS directly to the serializer 223 to be written into the DIO. In these embodiments, the parser 221 reads or otherwise obtains the SIO from a host app 202 via the FIDD API 210, and may provide the FILS_s1 to the transformer 222 (for transformation) or directly to the serializer 223 (transcoding) via the FIDD API 210. Furthermore, the transformer 222 could also route the resulting FILS_s2 to the serializer 223 via the FIDD API 210.

In some embodiments, the FILS may be a data stream(e.g., byte or character stream). In these embodiments, the FILS is a stream of tokens or data fragments, which are referred to as “events” (discussed in more detail infra). In other embodiments, the FILS may be a format-independent object model(FIOM) object. The FIOM object is an in-memory object representation of an InOb having a structure or arrangement of data items that is not dependent on a data format 260. The FIOM object may be an aggregate, tree structure, object hierarchy, graph, finite automaton or FSM, or other data structure including a hierarchy of one or more nodes, each of which corresponds to a different part of the InOb(e.g., elements, tags, data items, values, parameters, and/or the like). The FIOM may enable programmatic access to the elements and attributes of the FIOM via the FIDD API 210, which allows the structure or content of the FIOM to be modified. In some embodiments, the FIOM may be a map(also referred to as a dictionary, hash or hash table, associative arrays, or the like), which is a data structure comprising a set of entries. Each entry comprises a key and an associated value (e.g., a key-value pair(KVPs)). Each value in each entry may be a data element in an SIO and the associated key of that entry may be a data value. Both types of FILS are specific instances of the FIDD API 210 for communicating parsed data.

The parser 221 is a program, app, module, engine, compiler, and/or the like, that can read and process SIOs to break the SIOs into smaller elements, such as individual components or individual data items, and provides those elements to other entities through the FIDD API 210. A host app 202 provides the SIO to the parser 221 via the FIDD API 210. The SIO may be streamed from a host app 202 to the parser 221, for example, when the SIO is sent to the processor 220 at app runtime and/or in real-time so that the SIO may be parsed serially.

In various embodiments, the parser 221 is configured with a codec 252 associated with a source format 260, which includes format-specific functions, methods, tasks, parameters, constraints, and/or the like, that define the manner in which the parser 221 parses the SIO. Additionally, the parser 221 can be configured with a schema 232 associated with the SIO data format 260, which includes rules and constraints for parsing the SIO.

The parser 221 converts an SIO into data fragments, where each fragment is referred to as a “token” or an “event.” Each event may correspond to a string of character data, a sequence of bits, a type of markup(e.g., an element or tag), a processing instruction(or a beginning delimiter of a processing instruction), or some other unit or item that indicates a change between individual portions/sections of the InOb. Although an event may include a portion of a data item or multiple data items, the terms “event” and “data item” may be used interchangeably throughout the present disclosure. The parser 221 breaks the SIO into discrete events based on certain characters in the SIO that are known to delimit different portions of the SIO, or based on metadata in the schema 232 describing the locations, sizes, boundaries and/or other characteristics of fragments(e.g., based on position or bit length). After the parser 221 has broken the SIO into individual events, the parser 221 may arrange the events into a suitable FILS and may send the FILS to a FILS receiver (e.g., transformer 222, serializer 223, or a host app 202). In some implementations, the parser 221 is a pull parser that allows the FILS receiver to pull(e.g., call methods, functions, and/or the like, of the FIDD API 210) FILS data from the parser 221. In other implementations, the parser 221 is a push parser that pushes (e.g., sends) FILS data to the FILS receiver as the FILS data is generated.

As alluded to previously, the FILS may be an event stream or a FIOM object. Where event streams are used, the parser 221 sends the events in a particular sequence to the transformer 222 or serializer 223. The sequence of the events may be defined by a format independent schema format, and may correspond to the paths in finite automata(see e.g., FIG. 4).

In other embodiments, the parser 221 arranges the parsed data(e.g., events) into a FIOM object based on the declarative description of the source schema 232. In such embodiments, the parser 221 may include a specific engine/module (or call a separate engine/module) to construct the FIOM object. For example, where the logical data structure is a tree structure, this engine/module may be a tree builder module (TreeBuilder). The FIOM object generated from the SIO(e.g., output by the parser 221) may be referred to as an “input FIOM object” or “source FIOM object.”

The transformer 222 is a software element that transforms some input of a certain language or format into an output in some other language or having some other format or arrangement of data items. In embodiments, the transformer 222 configures the parser 221 with a codec 252 developed for source format 260, configures the serializer 223 with a codec 252 developed for the desired destination format 260, and then routes the output of the parser 221 to the input of the serializer 223. For example (and with reference to FIG. 2), if the source format 260 is “format 1” and a destination format 260 is “format Y”, then the transformer 222 configures the parser 221 with the format 1 codec 252, configures the serializer 223 with a format Y codec 252, and then routes the output of the parser 221 to the input of the serializer 223 for the conversion from format 1 to format Y. In some embodiments, the transformer 222 may use the FIDD API 210 to connect and invoke the appropriate parser 221 and serializer 223.

Furthermore, the transformer 222 may also apply one or more data transforms to the parsed data(e.g., the FILS) to rearrange the parsed data to conform to a different logical schema. Where FIOM objects are used, the transformer 222 may manipulate and/or rearrange the data items in the source FIOM object to produce a destination FIOM object that has a different arrangement of data items than the source FIOM object. In these embodiments, the transformer 222 may use a transformation specification(or a “transform”) that defines the mapping between the source FIOM object and destination FIOM object (e.g., XSLT or the like). Where event streams are used, the transformer 222 may manipulate and/or rearrange the sequence of events output by the parser 221 to produce a different sequence (order) of events. In these embodiments, the transformer 222 may use a suitable transform and/or encoding scheme to rearrange the sequence of events. Since transforms are independent of data formats 260, the FILS can be transformed from one schema 232 to another schema 232, and the transformed data can be written into any format 260.

The transformer 222 also configures the parser 221 and the serializer 223 with a schema 232 as well as respective codecs 252. As mentioned previously, the schemas 232 provide the parser 221 and the serializer 223 with an understanding of the logical structure and content of respective data formats 260. The parser 221 and the serializer 223 use this understanding to navigate the logical structure of InObs according to their data formats 260, and delegate the details of the physical representation of individual data formats 260 to one or more format-specific codecs 252 through the format-independent codec API 240. The parser 221 and the serializer 223 communicate the FILS read or written from specific data formats 260 to a calling host app 202 via the FIDD API 210. As such, the apps 202 and/or the processor 220 can read and write the same logical information to/from different data formats 260 using the same FIDD API 210 and the same software entities.

The FIDD API 210 specifies a set of subroutines, communication protocols, methods, functions, data structures, object classes, and/or the like. that allow the app(s) 202 to access services provided by the parser 221, transformer 222, and serializer 223. For example, each of the FIDD API 210 may specify the names of functions that the app(s) 202 can call, argument types and return values for those function calls, effects of calling particular functions, and/or the like. In one embodiment, the FIDD API 210 is an industry standard API so that data from a wide range of standard software modules and tools can be routed to and from the FIDD parser 221 and serializer 223 and easily read and written to/from a wide range of data formats 260. Examples of the industry standard APIs used to implement the FIDD API 210 include Simple API for XML (SAX), XQuery API for Java, Streaming API for XML(StAX), Java API for XML Processing (JAXP), and/or the like. In other embodiments, the FIDD API 210 may be implemented as a remote or web API such as a Representational State Transfer (REST or RESTful) API, Simple Object Access Protocol(SOAP) API, and/or some other like API. Additionally or alternatively, the FIDD API 210 may be implemented as a web service including, for example, Apache® Axi2.4 or Axi3, Apache® CXF, JSON-Remote Procedure Call(RPC), JSON-Web Service Protocol(WSP), Web Services Description Language (WSDL), XML Interface for Network Services (XINS), Web Services Conversation Language (WSCL), Web Services Flow Language (WSFL), RESTful web services, and/or the like.

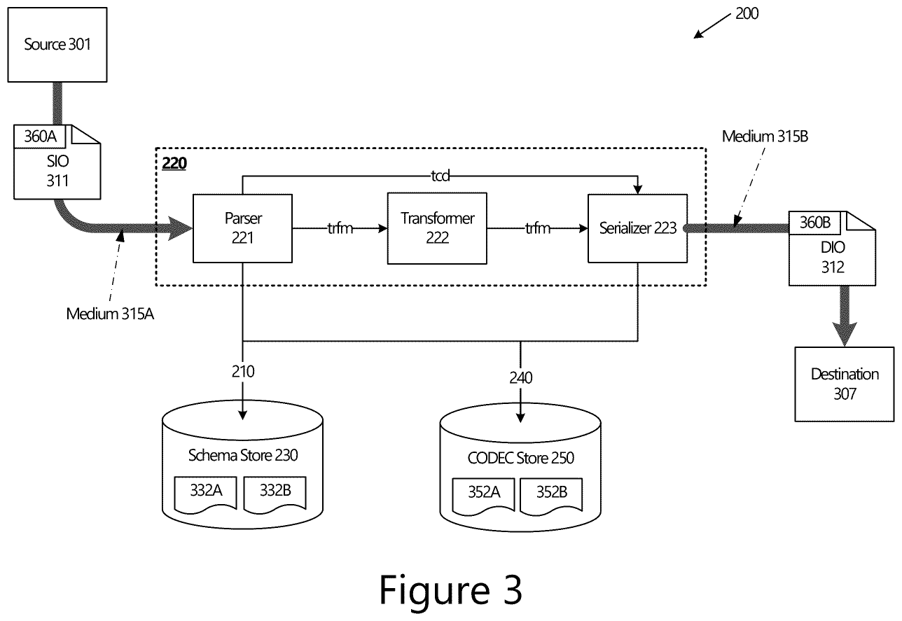

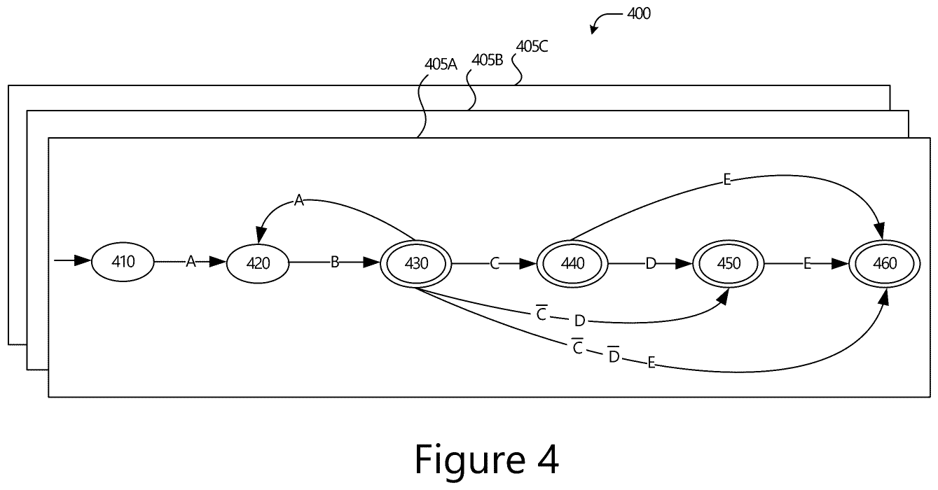

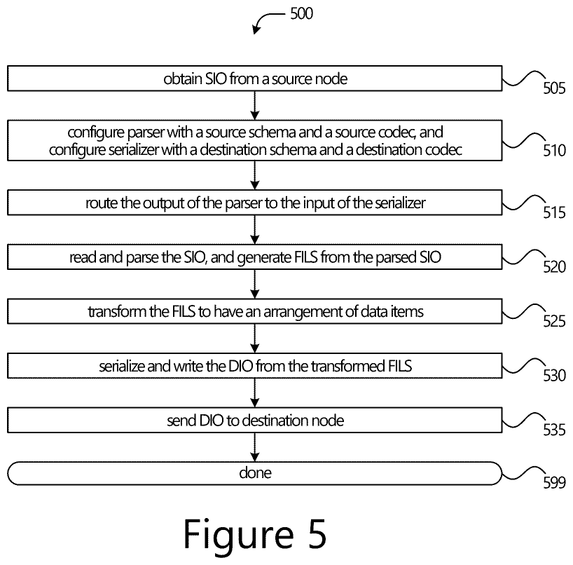

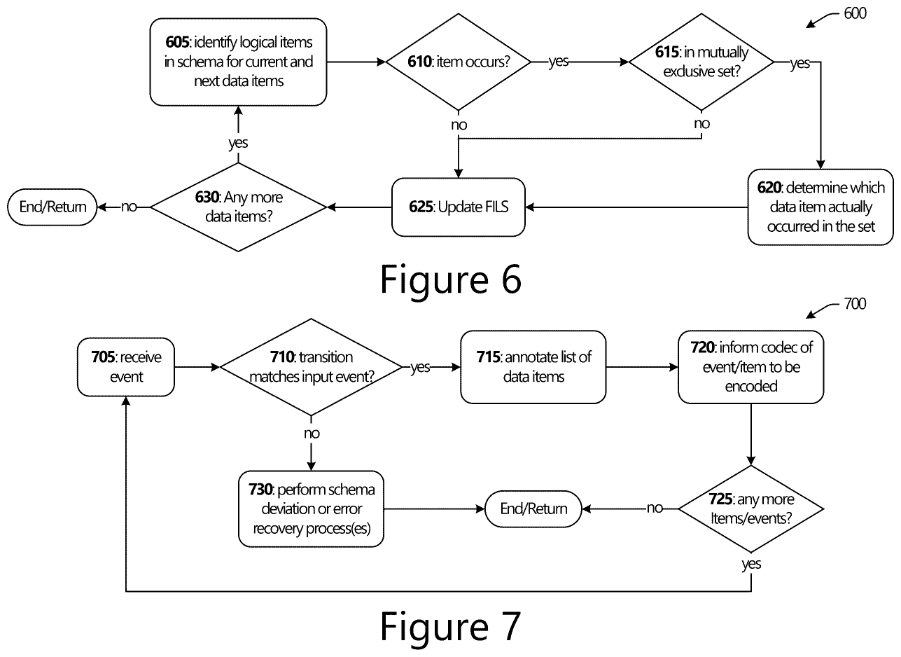

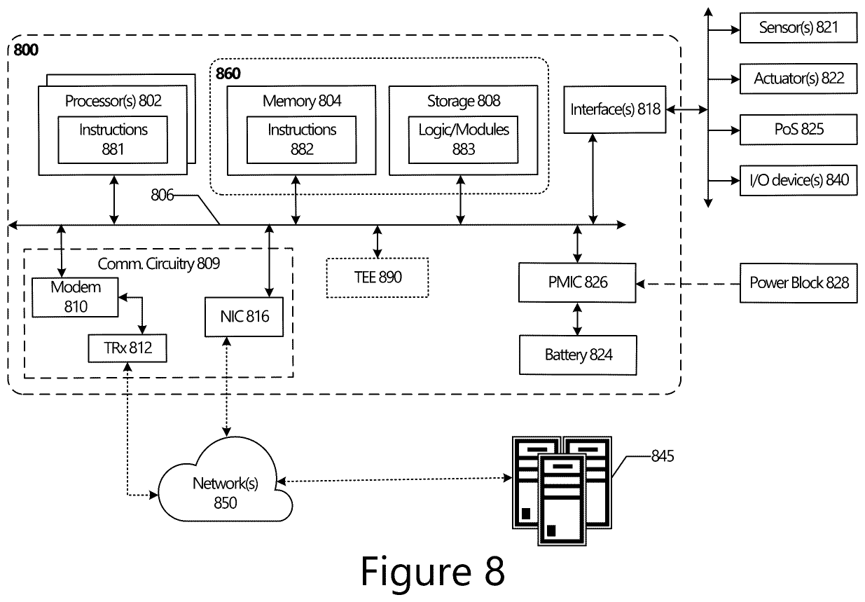

The serializer 223 is a program, app, module, engine, and/or the like, that can receive a collection of data items from the translator 222, the parser 221, or a host app 202 via the FIDD API 210, and write the data items into a specific data format 260 (e.g., a destination format 260). In some implementations, the collection of data items include parsed data that was parsed by the parser 221, while in other implementations the collection of data items does not include parsed data. Additionally or alternatively, the collection of data items may be generated directly by one or more apps 202, extracted from one or more databases, and/or obtained from some other data source (s). Serialization involves translating or converting a collection of data items into a sequence of data in a specific physical format. In some embodiments, the serializer 223 may first compute a normalized sequence of data for the serialization where a result of the sequence normalization is the DIO or a result of the serialization after the normalization is the DIO. The serializer 223 processes the collection of data items to generate (or write) the DIO in a destination format 260 using format-specific functions, methods, tasks, parameters, constraints, and/or the like, as defined by a codec 252 associated with the destination data format 260. The rules governing the output of the serializer 223, and various parameters used to control the serialization, are defined by a schema 232 of the destination format 260. The serializer 223 may be configured to write the data of the DIO according to the destination format 260 with or without compression. In some embodiments, the serializer 223 may compress the data of the DIO before writing it based on the logical data structure. Furthermore, the FIDD API 210 may define mechanisms enabling the sequence of data output by the serializer 223 to be written to a location in a local memory/storage or a remote location(e.g., destination node 307 of FIG. 3).

In some embodiments, the serializer 223 constructs a DIO in a desired destination format 260 from a FILS as discussed previously. In these embodiments, the serializer 223 is configured with a codec 252 associated with the desired destination format 260, which includes format-specific functions, methods, tasks, parameters, constraints, and/or the like, that define the manner in which the serializer 223 is to serialize the FILS into the DIO. Additionally, the serializer 223 is configured with a schema 232 associated with the data format 260, which includes rules and constraints for serializing the FILS based on the logical destination format 260. In some embodiments, the serializer 223 is or includes an interface that defines a fast, non-cached, forward-only means of generating (writing) streams or files containing data items in the destination format 260.

In embodiments, the KDF 200 includes a codec store 250 that stores a plurality of codecs 252-1 to 252-N(where N is a number). The codec store 250 may be a same or similar store as the schema store 230, although the codec store 250 may be stored on a different data storage device/system than that used to store the schema store 230. In various embodiments, the codec store 250 comprises one or more class files stored on a computer-readable medium that are loaded into memory by a classloader at runtime. In these embodiments, the codecs 252 are retrievable from the codec store 250 using a class name. In other embodiments, a database may be used to store the codecs 252. In these embodiments, codec store 250 may be physically stored in one or more data storage devices or data storage systems that act as a repository for persistently storing and managing collections of data according to a predefined database structure. The data storage devices/systems may include one or more primary storage devices, secondary storage devices, tertiary storage devices, non-linear storage devices, and/or other like data storage devices. In some implementations, one or more data storage devices/systems and/or one or more servers operate as a suitable database management system(DMS) to execute storage and retrieval of information against various database object (s). The DMS may include a relational database management system(RDBMS), an object database management system(ODBMS), a non-relational database management system, and/or the like. A suitable query language may be used to store and retrieve information in/from the codec store 250, such as Structure Query Language (SQL), NoSQL, object query language (OQL), non-first normal form query language (N1QL), XQuery, XPath, and/or the like. Suitable implementations for the database systems and storage devices are known or commercially available, and are readily implemented by persons having ordinary skill in the art.

Each codec 252 comprises program code, source code, modules, engines, functions, tasks, and/or other software entities/elements that are used to code InObs into a physical representation defined by a data format 260 and decode physical representations defined by a data format 260 into InObs. Additionally or alternatively, the codecs 252 are used to assist in assessing InObs according to their data format 260. The codecs 252 themselves are not apps; rather, each codec 252 is a piece of code that implements the codec API 240. In one embodiment, each codec 252 can be specified or developed by choosing an appropriate set of coding strategies from a predefined library, API(e.g., codec API 240), or the like. Additionally or alternatively, each codec 252 can be specified or developed by providing custom(user-defined) coding strategies via one or more coding algorithms.

The codec store 250 includes a codec 252 for each data format 260 to which an InOb is to be transformed. In FIG. 2, the KDF 200 includes a codec 252-1 to 252-N(where N is a number) for each of formats 1 to Y(where Y is a number), for example, a format 1 codec 252 corresponds to a format 1 data format 260, a format 2 codec 252 corresponds to a format 2 data format 260, a format 3 codec 252 corresponds to a format 3 data format 260, a format 4 codec 252 corresponds to a format 4 data format 260, and so forth to a format N codec 252 corresponds to a format N data format 260. Each codec 252 includes a set of one or more specifications, subroutines, methods, functions, data structures, equations, objects, object classes, instructions and/or the like, that are used to describe, decode or interpret specific aspects of an input(or obtained) InOb on behalf of KDF processor 220, which provides the decoded InOb to one or more apps through FIDD API 210. The decoding process may involve parsing a SIO based on the particular details of a corresponding data format 260. Additionally, each codec 252 includes a set of one or more specifications, subroutines, methods, functions, data structures, equations, objects, object classes, instructions and/or the like, that are used by the processor 220 to code the logical data structures into a corresponding destination data format 260.

The codec API 240 defines the various services the codec 252B makes available to the serializer 223. The codec API 240 specifies a set of subroutines, communication protocols, methods, functions, data structures, object classes, and/or the like. that allows parser 221 and serializer 223 to access services/functionality provided by individual codecs 252. The parser 221 and serializer 223 use the codec API 240 to invoke functions, methods, and/or the like, of the appropriate codecs 252. For example, each of the codec API 240 may specify the names of functions that the parser 221 or serializer 223 can call, argument types and return values for those function calls, effects of calling particular functions, and/or the like. Any of the API technologies discussed herein may be used to implement the codec API 240. In various embodiments, the codec API 240 includes a FIDD set of format-specific tasks that the codecs 252 may perform to facilitate writing and reading logical information to/from one or more data formats 260.

In one embodiment, the format-specific tasks to support reading an instance of a source data format 260 of an InOb include determining a particular logical data structure a given instance of the data format 260 represents(e.g., a message identifier (ID)); determining whether a next data item permitted in an instance of the data format occurs(e.g., whether optional, repeatable, or mandatory); determining which of a set of mutually exclusive data items permitted next in the an instance of the data format 260, actually occurs; and reading the next data item from the data stream or InOb, given a logical description of its content(e.g., an integer from 1 to 31), which come from the schema and/or schema annotations. The first part of the process may include inspecting a physical stream of bits(e.g., binary message) and determining which logical message it represents via some identifier (e.g., the aforementioned message ID). For example, in XML the message ID would be the qname of the root element. This occurs via the getRootElementQName ( ) method in the Binary Reader API 240 (discussed infra). The message ID is used to locate the top-level schema of the message, which describes all the structures and data elements in the message.

In one embodiment, the format specific tasks may include the following to support writing an instance of the data format: indicate which physical message the instance of the logical data being written represents; indicate whether the next data item permitted in the instance of the data format being written occurs or not(whether optional, repeatable, or mandatory); indicate which of a set of mutually exclusive data items permitted next in the instance of the data format being written, actually occurs; write the next data item to the stream, given the value to be written and a logical description of the data item's content(e.g., an integer from 1 to 31), which come from the schema and/or schema annotations; and determine whether a data item expected next in the instance of the data format 260 being written according to the schema 232 may be omitted or a data item that is not expected next according to the schema 232 may occur in the instance of the data format 260 being written (e.g., for handling schema deviations and error recovery).

FIG. 3 illustrates example logical interactions between elements of the KDF 200. In this example, the source node 301 may wish to send an SIO 311 to a destination node 307. However, the source format 360A of the SIO 311 may not be intelligible or consumable by the destination 307. This may lead to a data format 260 mismatch between the source 301 and destination 307. As alluded to previously, the processor 220 is an intermediary that translates the SIO 311 into the DIO 312 having a format 360B that is intelligible or consumable by the destination node 307. The data format of the SIO 311 when it is obtained by the processor 220 is referred to as a “source format 360A” and the data format of the DIO 312 to be sent by the processor 220 to the destination node 307 is referred to as a “destination format 360B.” The source format 360A and the destination format 360B may be among the plurality of source formats 260 discussed previously with regard to FIG. 2. The following examples are described where the source format 360A of the SIO 311 is different than the destination format 360B of the DIO 312, however, in some examples the source format 360A and the destination format 360B could be the same format (e.g., the identity transform). Although the following discussion provides an example of translating an SIO 311 to a DIO 312, other implementations and/or use cases are also possible according to the various embodiments discussed herein. For example, the various embodiments discussed herein can be used to convert an SIO 311 to a FILS and/or to convert a FILS into a DIO 312. Additionally or alternatively, the various functions described herein could be used by an application(e.g., an app 202) for reading, writing, parsing, and/or serializing SIO(s) 311 and/or DIO(s) 312.

The source 301 and destination 307 may be any of the systems 105-135, or may be apps 202 operated by the same or different systems 105-135. In one embodiment, the KDF 200 may be implemented by the source 301 or the destination 307. In another embodiment, the KDF 200 may be implemented by an entity separate from the source 301 and destination 307 such as a GW 150 discussed previously with respect to FIG. 1. In either of these embodiments, the source 301 and the destination 307 may be separate systems 105-135. In one example, the source 301 is an IoT device 105 and the destination 307 may by a(cloud) service provider 135 that provides KDF 200 services. In another example, the source 301 is a user system 110 that implements the KDF 200 and the destination 307 is a satellite system 130 that may or may not implement its own KDF 200. In another example, the source 301 is an IoT device 105 and the destination 307 may by an aerial systems 125 and the KDF 200 may be implemented by a GW 150. In any of these embodiments, the SIO 311 and/or DIO 312 may be human-readable or machine-readable InObs.

In other embodiments, the source 301 and the destination 307 are implemented by the same system 105-135. In one example, the source 301 is a first app 202 operated by a user system 110 and the destination 307 is a second app 202 operated by the user system 110. In another example, the source 301 is an app 202 operated by the user system 110 and the destination 307 is a selected memory location or a directory/path of a file system operated by the user system 110. In another example, the source 301 is a first memory buffer and the destination 307 is the same or different memory buffer. In any of these embodiments, the SIO 311 and/or DIO 312 may be human-readable or machine-readable InObs.

In the example of FIG. 3, the source 301 sends the SIO 311 to the KDF processor 220 over a medium 315A. In embodiments where the source 301 and KDF 200 are implemented by the same system 105-135, the medium 315A may be a software connector, software glue, middleware, API, ABI, driver, and/or any other means of communication between apps and/or services. Where a system 105-135 is using the processor 220 to translate data locally, the medium 315A could represent one or more memory buffers, a file system or directory, or the like. In embodiments where the source 301 and KDF 200 are implemented by different systems 105-135, the medium 315A may be a wired or wireless communication interface and/or protocol, such as any of those discussed herein, any of those discussed in [′295], and/or those not explicitly described herein.

The parser 221 receives the SIO 311, breaks the SIO 311 into its constituent parts/elements(e.g., events), and generates a FILS from the parsed data. As mentioned previously, the FILS is either a sequence of events(“event stream”) or a FIOM object. For performing data transformation, the FILS is provided to the transformer 222 over a first trfm interface. For transcoding, the parser 221 sends the FILS to the serializer 223 over the ted interface, or the FILS could be passed transparently through the transformer 222 to the serializer 223 via the respective trfm interfaces. In either case, the trfm interface and the ted interface are defined by the FIDD API 210.

The parser 221 is configured with a codec 352A developed for the source format 360A via the codec API 240. The codec 352A developed for the source format 360A may be referred to as a “source codec 352A.” The source codec 352A may be one of the codecs 252 stored in the codec store 250. The codec 352A tells the parser 221 how to read and parse data in the SIO 311 according to the physical source format 360A. The parser 221 breaks the SIO 311 into a sequence of events using the logical structures defined by the schema and various physical coding strategies embodied in the source codec 352A. The parser 221 does this by navigating the logical structure and invoking various codec API 240 calls defined by the codec API 240 as discussed in more detail infra.

Additionally, the parser 221 is configured with a schema 332A developed for the source format 360A via the FIDD API 210. The schema 332A developed for the source format 360A may be referred to as a “source schema 332A.” The source schema 332A may be one of the schemas 232 stored in the schema store 230. The parser 221 determines a logical data structure that an instance of the SIO 311 represents using the configured schema 332A to navigate or otherwise analyze the SIO 311.

Furthermore, in embodiments where the parser 221 creates a FILS, the parser 221 may construct or arrange the parsed data(e.g., data items) into the FILS according to a format independent schema format(FISF). In some embodiments, the FISF may be one of the schemas 232 stored in the schema store 230. Additionally or alternatively, the arrangement of data items in the SIO 311, as defined by the configured schema 332A and/or as determined by the parser 221, informs the arrangement of data items or nodes in the FISF. In some embodiments, the particular language, syntax, vocabulary, parameters, arguments, and/or other like criteria related to the schema 332A informs the FISF. In these embodiments, the parser 221 may develop the FISF for a particular SIO 331 “on the fly” as the parser 221 is reading and parsing the SIO 311. The schema 332A and/or the FISF may be loaded into the KDF processor 220 (or parser 221) via the FIDD API 210 and referenced during the parsing process, and/or the parser 221 may invoke various FIDD API 210 calls defined by the FIDD API 210 to access the logical information in the schema 332A and/or the FISF.

The codec API 240 is an interface that allows the parser 221 to obtain services from the appropriate codec 352A. The sequence and nature of the codec API 240 calls that the parser 221 makes to the codec 352A is driven by the schema 332A. If the schema 332A indicates that the next data item that may occur in the message is an optional data item, the FIDD processor 220 (or parser 221) uses the codec API 240 to ask the codec 352A via appropriate code API 240 call(s) whether that optional data item occurred or not. Based on the returned answer, the parser 221 navigates to the next part of the schema 332A and asks the next question the schema dictates. If the schema 332A indicates that the next data item that may occur has a mutually exclusive set of choices available, the FIDD processor 220 (or parser 221) asks the codec 352A via appropriate code API 240 call(s), which of the possible data items in the choice actually occurred. Based on the answer from the codec 352A, the parser 221 navigates to the next part of the schema 332A and continues to ask questions until the process completes (e.g., the parser 221 reaches the end of the schema 332A for that message). An example portion of the codec API 240 that the parser 221 may use to communicate with the codec 352A is shown by table 1.

TABLE 1
Binary Reader API

```
public interface BinaryReader
{
  public void initialize(BufferingXMLReader reader, ReaderContext context) throws
BinaryReaderException;
  public void setSchema(SchemaInfo schemaInfo) throws BinaryReaderException;
  public void setMessageDefinition(MessageDefinition msgDefinition);
  public void setInputStream(IBitwiseInputStream inputStream);
  public IBitwiseInputStream getInputStream( );
  public void startMessage(String schemaId, String uri, String localName, String qName) throws
BinaryReaderException;
  public String getRootElementQName( ) throws BinaryReaderException;
  public boolean didOccur(String uri, String localName, String qName, int particleId, int
minOccurs, int maxOccurs, XSTerm xsContext) throws BinaryReaderException;
  public int whichChoice(int nChoices, XSTerm xsContext) throws BinaryReaderException;
  public String readValue(Codec codec, Facets facet) throws BinaryReaderException;
  public void endMessage(String schemaId, String uri, String localName, String qName) throws
BinaryReaderException;
  public void terminate(String schemaId) throws BinaryReaderException;
  public String getMessageId( ) throws BinaryReaderException;
  public String resolveForwardReference(XSElementDeclaration fieldDecl) throws
BinaryReaderException;
}
```

In some embodiments, the parser 221 may build one or more deterministic finite automaton(DFA) to represent the logical structure of the source schema 332A, an example of which is shown by FIG. 4. It should be noted that the binary reader API 240 shown by table 1 shows the functions that the parser 221 may call. However, the order in which those functions are listed is not necessarily the order in which they are called. For the parser 221, the order of calls is determined by the order of data items defined by the schema 332A and the answers(values) returned from calling individual functions in the binary reader API 240. As discussed in more detail infra with respect to FIG. 4, as each data item in the SIO 311 is encountered, the schema 332A will indicate the next mandatory or optional data items that should occur in the SIO and constraints on the data item that need to be processed(e.g., to resolve or assess the data item), which will influence the particular binary reader API 240 call to be invoked. The next binary reader API 240 call to be invoked will then be based on the next mandatory or optional data item(s) indicated by the schema 332A and the answer (values) received in response to calling the binary reader API 240 call.

Continuing to refer to FIG. 3, the transformer 222 applies one or more transforms to the FILS generated by the parser 221. The transformer 222 may use a transformation specification to determine how to transform the FILS from one FISF (e.g., the source FILS or the FILS_s1 as discussed previously) into a FILS that fits a different FISF (e.g., the destination FILS or the FILS_s2 as discussed previously). An external transform specification defines how the source FILS is mapped to the destination FILS. An open standard transformation language may be used to transform the FILS. Examples of open standard transforms include XML transformation languages (e.g., XSLT, XQuery, Scala, and/or the like), Atlas Transformation Language (ATL) provided by the Eclipse Foundation™, the AWK programming language, the TXL programming language, MOF Model to Text Transformation Language (Mof2Text), Query/View/Transformation (QVT), Stratego transformation language and Stratego/XT, JSONata, Patch-Like Transformation Language (PATL), Yet Another Transformation Language (YATL), and the like.

The serializer 223 receives the transformed FILS from the transformer 222 via the FIDD API 210, and serializes, writes, or otherwise generates the DIO 312 in the destination format 360B. When transcoding, the serializer 223 may receive the FILS directly from the parser 221 via the FIDD API 210, and may serialize, write, or otherwise generate the DIO 312 in the destination format 360B.

The serializer 223 is configured with a schema 332B developed for the destination format 360B via the FIDD API 210. The schema 332B developed for the destination format 360B may be referred to as a “destination schema 332B.” The destination schema 332B may be one of the schemas 232 stored in the schema store 230. The serializer 223 determines a logical data structure that an instance of the DIO 312 represents using the configured schema 332B.

Additionally, the serializer 223 is configured with a codec 352B developed for the destination format 360B via the codec API 240. The codec 352B developed for the destination format 360B may be referred to as a “destination codec 352B.” The destination codec 352B may be one of the codecs 252 stored in the codec store 250. The codec 352B tells the serializer 223 how to serialize and/or write certain aspects of the FILS into the DIO 312 according to the physical destination format 360B. The serializer 223 does this by invoking various API calls defined by the codec API 240. An example portion of the codec API 240 that the serializer 223 may use is shown by table 2.

TABLE 2
Binary Writer API

```
public interface BinaryWriter
{
  public void initialize( ) throws BinaryWriterException;
  public void setSchema(SchemaInfo schemaInfo) throws BinaryWriterException;
  public void setOutputStream(IBitwiseOutputStream outputStream);
  public IBitwiseOutputStream getOutputStream( );
  public void startMessage(String schemaId, String uri, String localName, String qName) throws
BinaryWriterException;
  public void setMessageId(String msgId) throws BinaryWriterException;
  public void occur(boolean doesOccur, int occurCount, String uri, String localName, String
qName, int particleId,
    int minOccurs, int maxOccurs, XSTerm xsContext) throws BinaryWriterException;
  public void choice(int nChoices, int whichChoice, XSTerm xsContext) throws
BinaryWriterException;
  public void writeValue(String value, Codec, Facets facet) throws BinaryWriterException;
  public boolean mayOccur(boolean doesOccur, int occurCount, String uri, String localName,
String qName, int particleId,
    int minOccurs, int maxOccurs, XSTerm xsContext) throws BinaryWriterException;
  public void endItem(String uri, String localName, String qName) throws BinaryWriterException;
  public void endMessage(String schemaId, String uri, String localName, String qName) throws
BinaryWriterException;
  public void terminate(String schemaId) throws BinaryWriterException;
  public void setDebugTrace(boolean debugTrace);
}
```

Similar to the parser 221, the serializer 223 obtains services provided by the destination codec 352B via the codec API 240. The order in which the serializer 223 invokes the functions/methods of the binary writer API 240 of table 2 is driven by the order of events(data items) in the FILS provided by a FILS provider (e.g., transformer 222, parser 221, or a host app 202) and the schema 332B(e.g., represented by a DFA stack 400 as shown and described with respect to FIG. 4). Here, the “events” may be individual events in an event stream or individual nodes in a FIOM object, and may correspond to individual data items or portions thereof. As an example, the FILS provider uses the FIDD API 210 to tell the serializer 223 to write a particular event or data item, and the serializer 223 will make a number of calls to the occur( ) method in the binary writer API 240 to tell the codec 352B that zero or more events did not occur and that the particular event did occur, depending on the order of events defined by the schema 332B. This gives the codec 352B an opportunity to record the events(or non-events) in a format-specific manner (e.g., by using a presence bit to indicate whether a given event occurs). If the schema 332B indicates that the next event(data item) that can occur is a mutually exclusive choice between two or more events, and the FILS provider uses the FIDD API 210 to tell the serializer 223 that a specific event of the two or more events has occurred, the serializer 223 uses the choice ( ) method of the binary writer API 240 to tell the codec 352B which of the possible choices actually occurred. If the app uses the FIDD API 210 to tell the serializer 223 to write a specific value (e.g., “5”), the serializer 223 will consult the schema 332B to determine what kind of value this is(e.g., an integer in the range 1-31) and will use the writeValue ( ) method of the binary writer API 240 to tell the codec 352B to write this value to the DIO 312 in a format-specific manner. If the item just written was a complex type element that has nested child elements, the serializer 223 will lookup and switch to the appropriate DFA(see e.g., FIG. 4) that defines the content model of that complex type.

Furthermore, the serializer 223 also has a way to deal with unexpected content, such as extensions or schema deviations. If the FILS provider asks the serializer 223 to write an event that is not allowed or expected at this point in the schema 332B, the serializer 223 can use the mayOccur( ) method of the binary writer API 240 to inform the codec 352B of the unexpected data item and ask whether it is permitted to write the unexpected event. If the codec 352B can handle the deviation and permits the codec 352B to write the unexpected event, the serializer 223 will continue processing. Similarly, if a mandatory data item is missing, the serializer 223 can use the mayOccur( ) method in the binary writer API 240 to ask the codec 352B whether the mandatory data item missing is acceptable, for example, by calling mayOccur(false, . . . ). The serializer 223 can use a combination of these calls to handle unexpected data items and perform error recovery.

After the DIO 312 is written in the destination format 360B, the serializer 223 prepares or packages the DIO 312 for transmission over the medium 315B. The generated DIO 312 includes some or all of the data values of the SIO 311 with an arrangement of data items defined by the destination schema 332B and encoded according to the destination format 360B. This arrangement of data elements may be different than the arrangement of data elements in the SIO 311. In some embodiments, the serializer 223 also packages the DIO 312 into one or more data packets, protocol data units(PDUs), frames, segments, and/or the like, according to the destination medium 315B and/or according to a desired data exchange format. In alternative embodiments, a separate encoder may be used to package the DIO 312 for transmission over the medium 315B. As mentioned previously, an encoder (not shown by FIG. 3) may be used to encode or package the DIO 312 into one or more messages for transmission over the medium 315B. The medium 315B may be the same or different than the medium 315A(e.g., the medium 315B may include any means of interconnection and/or communication, or combinations thereof, between apps, services, components, devices, systems, and/or networks, including any of those discussed herein, any of those discussed in [′295], and/or those not explicitly described herein). For example, the medium 315A may be a Link 16 Time Division Multiple Access(TDMA) network (where the SIO 311 is a J-series message/document, for example) and medium 315B may be HTTP over TCP/IP(where the DIO 312 is a JSON document, for example). In another example, a system 105-135 translating files on its local disk drive could obtain the SIO from a memory location or directory path, and write the DIO to the same or different memory location or directory path. In another example, a system 105-135 could be translating buffers in memory, where the SIO 311 represents data in a first memory buffer and the DIO 312 is translated data written and stored in the same or different memory buffer.

Additionally, the schemas 232 may include annotations, which are descriptions of constraints or parameters/arguments to be passed to the codec 252 with an associated event. The annotations are a type of metadata used to instruct the KDF processor 220 (configured with specific codecs 252) how to handle translation of unique or complex data formats 260, which may include passing additional information about specific data items that the schemas 232 or data formats 260 are not capable of conveying. The annotations may also be referred to as “markers,” “comments,” “indicators,” and/or the like. Adding annotations to the schemas 232 may simplify the development of codecs 252, which makes it easier to implement new data formats 260 faster. In embodiments, the annotations may include informative annotations, hidden data item annotations, synthetic data item annotations, conditional data item annotations, and forward reference annotations.

Informative annotations are used to inform the codec 252 of some aspect of a data item that is not discernable from the format 260. As examples, informative annotations can include a number of bits for encoding a field or data element; a range of values that a passed data value must fall within; and/or other like constraints.

The informative items are passed to the codec 252 as parameters via the codec API 240. For example, the serializer 223 may call the write Value ( ) method in the binary writer API 240 of table 2 to write a data item, and the writeValue ( ) passes the following parameters to the codec 352B: the value to be written (e.g., “String value” in table 2), the codec(e.g., “Codec codec” in table 2) which indicates the value type (e.g., integer, character, string, and/or the like), and facets (e.g., “Facets facet” in table 2). The facets indicate aspects or constraints on the passed value, such as a range of values for the passed value (e.g., between 1 and 31), number of encoded bits for the field, or the like. In this example, the codec and the facets may be considered metadata. In embodiments, the informative annotations are passed to the codec 252 as facets. In this example, the codec 252 receives the collection of facets, determines whether there are any informative annotations on the data item, and if so, the codec 252 can interrogate the facets to determine or identify the annotations. In another example, when reading a data item, the parser 221 may pass the codec 352A the name of the value to be read, the data type, and other metadata that can held in reading the data item. The metadata may include informative annotations that were included in the schema 332A, and the parser 221 will pull the annotations out of the schema 332A, associate the annotations with the data item, and then pass them along to the codec 352A when it is time to process that data item.

Hidden data item annotations are used to inform the codec 252 about hidden data items (or hidden fields), which are data items that might occur in a physical data format 260 to support specific coding strategies (e.g., the length of a length-prefixed string), but are not part of the logical information expressed or described in the associated schema 232 (e.g., the string itself). Examples of hidden data items include links, message bit lengths before translation, and the like. The informative annotations allow the codec 252 to know about the hidden data items that do not show up in the schema 232. Furthermore, the informative items may include value constraints that can be invoked by the codec 252 to compute data values for hidden and/or visible data items based on, for example, other data item values, the environment or knowledge of the data format. As an example, when the serializer 223 is writing data items, the serializer 223 may pass the codec 352B the hidden annotations with their value constraints(if any), and the codec 352B may use the value constraints to compute the data values for the hidden data elements.

The schemas 232 define the logical information that occurs in a given data format 260. The schemas 232 can be annotated with metadata about parameters or constraints that may occur in the physical format 260 that do not belong in the logical format(schema 232). This means that hidden data items are not represented as data element declarations in the logical representation, but instead are represented as annotations. Since the hidden data items are specified as annotations rather than in the main part of the schema 232, the hidden data items do not show up in the logical representation of that information. Instead, the hidden data items are represented as annotations in the schemas 232.

The hidden data items are automatically handled by the parser 221 or the serializer 223 in the same manner as other events/data items. In other words, the parser 221 and serializer 223 identify the hidden annotations in the schemas 232 and factor them into the logical representation (e.g., DFA 405 of FIG. 4) as if the hidden annotations were events(e.g., non-hidden data items). This allows the codecs 252 to have an opportunity to process hidden data items. The parser 221 and serializer 223 pass the hidden data items to their respective codecs 252 in the same way they would pass other events to the codecs 252. Markers placed on these events(indicating that they are hidden data items) allows the parser 221/serializer 223 to avoid generating data values for those events. In some embodiments, when processing the schema 232, a transform may be applied to the schema 232 (e.g., by the transformer 222) that converts all the hidden data items in the schema 232 into real(non-hidden) data items, and places annotation or markers on those data items indicating that they are in fact hidden items. In this way, the hidden data items are included in the logical representation of the schemas 232 (e.g., the DFAs 405 of FIG. 4 infra).

Synthetic annotations are used to inform the codec 252 about “synthetic items,” which are logical elements(e.g., data elements in a schema 232) that might occur in a schema 232 that are not expressed or described in the associated physical data format 260. Similar to the hidden data items, synthetic items may be expressed using value constraints that inform the codec 252 how to derive the data values for the data elements associated with the synthetic items. In an example, when the parser 221 is reading an SIO 311, the parser 221 may pass the codec 352A the synthetic annotations and their value constraints(if any), and the codec 352A may use the value constraints to compute the data values for the synthetic data elements.

Since synthetic items are part of the logical information schemas 232, they appear in the schema 232 in a same or similar manner as other schema components. However, these logical elements include annotations indicating that they are in fact synthetic items. The synthetic annotations appended to a schema component inform the parser 221 and serializer 223 that the schema component is a synthetic item, and as such, that the element, attribute, or type defined by that schema component is not in the physical data format 260. When synthetic data items (e.g., data items marked as being defined by the synthetic item in the schema 232) are passed to the codec 252, the transcoder 220 implementing the codec 252 will not try to identify those data items in the data format 260. The synthetic items are still passed to the codec 252 in case those synthetic items are particular to that format 260, and thus, the codec 252 may need to know whether they are occurring or not occurring.

As mentioned previously, the hidden annotations and synthetic annotations may include value constraints, which are used by the code 252 to calculate data values. A “value constraint” refers to a function, formula, equation, algorithm, method, and/or the like, used to calculate a data value. Value constraints may include other parameters use to calculate data values, and may indicate how to compute a data value using other items/elements that are in the message (InOb). If a value constraint is not included, then the transcoder 220 implementing a code 252 has to have some other way to determine the data value for a data element. In some embodiments, fixed values may be passed to the codec 252 instead of using value constraints. In some embodiments, the codec 252 has a trigger off of a portion of the provided annotations (e.g., using trigger verbs, trigger parameters, or the like), or has a trigger off of the name of the data item.

Conditional annotations are annotations used for conditional data items, which may be used for optional data items or when there is a choice between data items. For optional data items, the conditional annotations may include a constraint used for determining whether the optional data item is actually present(when decoding) or should occur(when encoding)(referred to as “conditional constraints”). The KDF processor 220 can use conditional constraints to determine whether the data item occurred or not(when decoding) or should occur(when encoding), with or without the help of the codec 252. However, in some implementations, these data items and annotations are still passed to the code 252 to give the codec 252 an opportunity to evaluate the data item and conditional constraint. In some implementations, conditional constraints are only used by the parser 221, although the embodiments herein are not limited to such implementations. In either case, if a data item has a conditional annotation, KDF processor 220 (using or not using the codec 252) evaluates the condition and returns a value such as “true” if the data item did occur or should occur and “false” if the data item did not occur or should not occur. When the codec 252 is used, the codec 252 may return the value using the codec API 240.

Conditional constraints may be used for choices between data items in the same or similar manner as they are used for optional data items. Conditional constraints may be attached to each data item in a set of mutually exclusive data items that is subject to a choice. For example, a choice between events A, B, C, and D may depend on a value of X that is defined elsewhere in the message. Similar to the conditional constraints for optional data items, the KDF processor 220 (using or not using a codec 252) evaluates the condition and returns a value of the selected event/data item(e.g., one of A, B, C, and D).

Conditional constraints may be declaratively specified in the schema 232 using conditional annotations, which indicate conditions that can be evaluated to determine whether or not optional items should occur or not and/or which of several mutually exclusive choices should be selected, or actually occurred. In one example implementation, XPath standards may be used to specify the conditions and constraints, and the value equations as well. These value constraints and conditions give the KDF processor 220 a way to compute data values, determine whether something occurred or not, and/or compute which choice was chosen or should be chosen without writing any code in the codec 252.

The value constraints and conditional constraints have references to other data items in the message (e.g., SIO 311 or FILS), which are then used to determine a data value or whether the item occurred or not. These data items referred to by the constraints may get resolved in a streaming fashion while the message is being read. Sometimes those references are forward references, which in the context of the present disclosure, are references to data items that appear at a later point in the message than a current data item being processed, or appear after the occurrence of the current data item being processed. This means that the referenced data item has not been read by the KDF processor 220, but is still needed to evaluate the constraint. Additionally, the processing of the InOb cannot continue until the constraints for the current data item are evaluated and/or assessed. In various embodiments, forward references are handled by finding the data items that are (or include) references, and analyze the schemas 232 with their annotations to determine whether those references occur farther ahead in the schema 232 of where the reference occurs in the schema 232. In embodiments, this takes place once at schema 232 load time. Part of the codec API 240 allows the processor 220 to work with the codec 252 in order to resolve the identified forward references. For example, the resolveForwardReference ( ) method in the binary reader API 240 of table 1 passes a schema 232 declaration of the item that needs to be read with all of its annotations and other parameters and/or constraints that might occur on that item. In some cases, the annotations may be specific enough to tell the codec 252 where to find the item in the message. In some embodiments, the codec 252 may jump ahead in the message to read the referenced item, although the codec 252 may resolve the item in variety of other ways.

The various embodiments as shown and described with respect to FIGS. 2-3 describe an example where a single SIO 311 is transformed into a single DIO 312. However, according to various embodiments, multiple SIOs 311 may be input to the KDF 200 and transformed into one or more DIOs 312. Additionally, in some embodiments, one or more of the multiple SIOs 311 may have different source formats 360A, for example, a first source format 360A of a first SIO 311 input to the KDF 20 may be Format 1 260, a second source format 360A of a second SIO 311 input to the KDF 20 may be Format 2 260, and so forth. In these embodiments, respective logical information schemas 232 may be used to navigate the logical structures represented by respective source formats 360A, and respective codecs 252 may indicate the various formatting decisions needed to processes respective SIOs 311. Thus, the depiction and discussion of the illustrative KDF 200 in FIGS. 2-3 should be taken as being illustrative in nature, and not limited to the scope of the present disclosure.

FIG. 4 illustrates an example deterministic finite automata(DFA) stack 400. For illustrative purposes, the DFA 405A is described with respect to the various elements of FIGS. 2-3; however, it should be understood that the following discussion is also applicable to DFAs describing other logical data structures represented by other data formats. As shown by FIG. 4, the DFA stack 400 includes individual deterministic finite automatons(DFA) 405 (including DFA 405a, DFA 405B, and DFA 405C), although many more DFAs 405 may be included in other embodiments. In some embodiments, the DFA stack 400 describes the sequences of elements that may occur in the logical data structure (e.g., a FILS), which represents a portion of a data format 260. Each DFA 405 in the DFA stack 400 may correspond to a FILS element output by the parser 221 or correspond to a FILS written to a DIO 312 by the serializer 223 (e.g., events in an event stream or nodes in a FIOM object).

Each DFA 405 may be a finite state machine (FSM) that describes the combinations of DEs that may form a portion of the SIO 311 and DIO 312 and produces a unique computation of the automaton for each input event. Each of the events may be individual events in an event stream or individual nodes in a FIOM object. The DFA 405A includes a plurality of states 410-460 (denoted by ovals in FIG. 4). For each state 410-460, there is a transition arrow leading to a next state for each possible input event. A state is a description of the status of the KDF processor 220 that is waiting to execute a transition. A transition may specify a set of actions to be executed when a condition is fulfilled or when an event is detected. Although the state transitions are only shown for DFA 405A, it should be understood that each DFA 405 may have different state transitions. Upon reading an event in the SIO 311, the DFA 405A deterministically transitions from one state to another following the transition arrow associated with the event. The DFA 405A includes a start state (e.g., state 410 denoted by an arrow coming in from no other node/state in FIG. 4) where computations begin, and a set of accept states or accepting states (e.g., states 430, 440, and 450 denoted by double ovals in FIG. 4) that define when a computation may terminate successfully. Each of the accepting states are valid ending states where the FSM may terminate, and the FSM must terminate when there are no transitions from the current state.

Each DFA 405 may represent a complex type element(e.g., <complexType>). A complex type element is a container or data element that contains other elements and/or attributes. A simple type element(e.g., <simpleType>) defines a simple type and specifies the constraints and information about the values of attributes or text-only elements. Simple type elements are atomic and may be an integer, a string, a date, and/or the like. Each of the data formats 260 have complex type elements and simple type elements, where the complex type elements allows collections of data items to be nested inside of another collection of data items or a sequence of data items inside a wrapper. Here, each DFA 405 is used to navigate through a particular complex type element and all the possible elements, values and attributes that can occur according to the sequences, choices, and occurrence constraints of data items defined in the associated schema definition. As alluded to previously, the source format 360A may include a plurality of events that may be represented by an InOb, as well as one or more attributes, values, namespaces, datatypes, and/or the like, for each event. The schema 332A may also specify the events that may appear in an InOb in any order, that individual events may include one or more specific child events, a specific sequence or order of events, a minimum number of times an event may occur, a maximum number of times an event may occur, and/or other like conditions, parameters. As an example, the schema 332A may define events A, B, C, D, and E for source format 360A is shown by table 3.

TABLE 3

```
<xsd:complexType name=”message”>
  <xsd:sequence>
    <xsd:sequence minOccurs=”1” maxOccurs=”unbounded”>
      <xsd:element name=″A” minOccurs=”1” maxOccurs=”1”/>
      <xsd:element name=″B” minOccurs=”1” maxOccurs=”1”/>
    </xsd:sequence>
  <xsd:element name=″C” minOccurs=”0” maxOccurs=”1”/>
  <xsd:element name=″D” minOccurs=”0” maxOccurs=”1”/>
  <xsd:element name=″E” minOccurs=”0” maxOccurs=”1”/>
</xsd:sequence>
```

In the example of table 3, the schema 332A indicates that the message may start with a repeated sequence of events that must occur at least once (minOccurs=1) and may repeat indefinitely(maxOccurs=unbounded); the repeated sequence contains exactly one even tA (minOccurs=1, maxOccurs=1), followed by exactly one event B; it may be followed by zero or one event C(minOccurs=0, maxOccurs=1); which may be followed-by zero or one event D; which may be followed by zero or one event E. Other attributes, names, values, and/or the like, may be defined for each event in other embodiments.

In embodiments, the KDF processor 220 uses codec API 240 calls to ask a codec 352A whether the specific events occurred in a given message (e.g., SIO 311). Continuing with the previous example, the KDF processor 220 makes codec API 240 calls to codec 352A to determine whether the events defined by the schema 332A, as shown by table 4.

TABLE 4

didOccur(A, 1,1, ...);
didOccur(B, 1,1, ...);
didOccur(A, 0,1, ...);
didOccur(C, 0,1, ...);
didOccur(D, 0,1, ...);
didOccur(E, 0,1, ...).

In the above example codec API 240 calls, the first parameter in the didOccur( ) call indicates the name of the event, the second parameter indicates the minOccurs, and the third parameter indicates the maxOccurs. The ellipsis(“ . . . ”) indicates that other parameters(e.g., all, choice, sequence, group, and/or the like) may be passed. Additionally, metadata about the nature of the event being read that enables the codec 352A to know how to read it in the data format 360A it implements. For example, the “didOccur(A, 0,1, . . . )” call checks to see if A was repeated after B; and if not, it would ask about C. Continuing with this example, the schema 332A definition may be represented as a set of events, as shown by equation(1) and/or equation(2).

$$R = [ \begin{matrix}( \begin{matrix}A \\ B\end{matrix} ) \\ \\ C ? \\ D ? \\ E ?\end{matrix} \qquad ( 1 )$$

$$( AB ) + C ? D ? E ? \qquad ( 2 )$$

In the examples of equations 1 and 2, “A” and “B” can be repeated as a group(e.g., one or more repetitions of(AB) followed by an optional “C”, optional “D”, and optional “E”). Additionally, the events including question marks(?) indicate optional events and events without question marks indicate mandatory events. In other words, the “?” symbol is used in a grammar to describe what could happen rather than an actual event sequence. The input events may be provided by the parser 221 based on processing the SIO 311 as discussed previously. The input events may be represented as shown by equation 3.

$$\sum = {\{ A , B , C , D , E \}}^{*} \qquad ( 3 )$$

Referring to DFA 405A, the processing of SIO 311 begins at starting state 410. An event A from sarting state 410 causes a transition to state 420. The event may be initiated by an instructions or indication made via the FIDD API 420 to the KDF processor 220 to read or write the event. If an event in the DFA 405 is a simple type element, then navigating a state transition causes that event to be read by the parser 221 or written by the serializer 223. In the example of FIG. 4, if event A happens to be a simple type element(e.g., an integer between 1 and 31), the transition from state 410 to state 420 may involve the codec API 420 providing an instruction or indication indicating that the codec 252 should read or write the value.

An input of event B from state 420 causes a transition to accepting state 430. As an example, the event B may be a complex type element, such as a customer record that has customer name element, customer address element, date of birth (DOB) element, and other customer-related elements/data items. In this case, the transition from state 420 to accepting state 430 may involve pausing the DFA 405A, pushing DFA 405A on the DFA stack and calling another DFA 405 (e.g., DFA 405B) to process the contents of the customer record. The other DFA 405B may be used to invoke API calls to read the customer name, followed by customer address, customer DOB, and so forth. Additionally, the customer address may be a complex type element, which includes, for example, a street address element, city element, state/province element, ZIP code element, and the like. A state transition in the other DFA 405B may involve pausing the DFA 405B, pushing DFA 405B on the DFA stack and calling another DFA 405 (e.g., DFA 405C) to process the contents of the customer address record. When the processing of the customer address record is completed by DFA 405C, the KDF processor 220 may pop DFA 405B off the DFA stack and resume using it to continue processing the customer record. When the processing of the customer record is completed by DFA 405B, the KDF processor 220 may pop DFA 405A off the DFA stack and resume using it to continue processing the other events of the SIO 311.

From accepting state 430, an input of event A causes a transition back to state 420; an input of event C causes a transition to accepting state 440; an input of event D causes a transition to accepting state 450; and an event E causes a transition to accepting state 460. From accepting state 440, an input of event D causes a transition to accepting state 450. From accepting state 440, and an input of event E causes a transition to accepting state 460. From accepting state 450, an input of event E causes a transition to accepting state 460. The presence of an event other than C(i.e., D) in the transition from state 430 to state 450, indicates that the event C is an optional data item. Similarly, the presence of an event other than D(i.e., E) in the transition from state 440 to state 460, indicates that the event D is also an optional data item.

In embodiments, the DFA 405 may explicitly represent optional items that are omitted when a particular transition is taken. For example, DFA 405A explicitly represents optional items that do not occur when a particular transition is taken using the Boolean not operator(e.g., C indicates C did not occur). These “not transitions” are meant to help the KDF processor 220 to communicate the sequence of data items declared in a schema 232 that do occur and do not occur when parsing or serializing a given message. This provides the codec 252 with an opportunity to read a particular data item from an SIO 311 or write something into the DIO 312 representing the fact that a given optional data item did or did not occur. For example, the serializer 223 uses the codec API 240 to send events to the codec 352B to give the codec 352B an opportunity to process data items, perform task(s), take action(s), and/or the like, for each data item to be written to the DIO 311. By sending the “not events” to the codec 352B, the serializer 223 has an opportunity to perform certain tasks or take certain actions when an optional event is missing as defined by the data format 360B. If the data format 360B being implemented requires the serializer 223 to do something when an optional data item is present, the serializer 223 is also able to take those actions. This also allows certain actions, tasks, and/or the like, to be performed by the serializer 223 based on the order/sequence of events, for example, when combined with annotations. The serializer 223 directly uses the schema 352B and the DFAs 405, which represent the information in the schema 352B, as its guide to drive that process. In one example implementation, the serializer 223 or codec 252 may write a presence bit with a value of “O” into the DIO 312 to indicate that a particular data item was absent or did not occur.

FIGS. 5-8 illustrate example processes 500-800, respectively. For illustrative purposes, the operations of each of processes 500-800 are described as being performed by the KDF 200 operated by the compute node 201 discussed previously with respect to FIG. 2. In embodiments, a processor system of the compute node 201 (e.g., processor circuitry 802 shown by FIG. 8) executes program code of the KDF 200 to perform the operations of processes 500-800. Additionally, a communication system of the compute node 201 (e.g., communication circuitry 809 of FIG. 8) may be used to communicate (transmit/receive) the described InOb and/or messages. While particular examples and orders of operations are illustrated in FIGS. 5-8, in various embodiments, these operations may be re-ordered, broken into additional operations, combined, and/or omitted altogether. Furthermore, in some embodiments the operations illustrated in FIG. 5-8 may be combined with operations described with regard to other example embodiments and/or one or more operations described with regard to the non-limiting examples provided herein.

Referring now to FIG. 5, where an example process 500 for providing a KDF is shown. Process 500 begins at operation 505, where the compute node 201 obtains an SIO 311 from a source node 301 via the FIDD API 210. At operation 510, the compute node 201 (or transformer 222) configures the parser 221 with a source schema 332A and a source codec 352A, and configures the serializer 223 with a destination schema 332B and a destination codec 352B. The source schema 332A describes a logical structure of the source format 360A, and the destination schema 332B describes a logical structure of the destination format 360B. In embodiments, the compute node 201 obtains the schemas 332A-B from the schema store 230 via a suitable API and obtains the codecs 352A-B from the codec store 250 via the same or different API. At operation 515, the compute node 201 routes an output of the parser 221 to an input of the serializer 223 potentially through transformer 222. In some embodiments, operation 505 may take place after operations 510 and/or 515.

At operation 520, the compute node 201 reads and parses the SIO 311, and generates a FILS from the parsed SIO 311 using a source codec 352A and according to the source schema 332A. In embodiments, the generated FILS has a first arrangement of a first format-independent schema. At operation 525, the compute node 201 transforms the FILS to have a second arrangement of data items according to a second format-independent schema format. In some embodiments, the second format-independent schema format is different than the first format-independent schema format. In other embodiments, the second format-independent schema format is the same as the first format-independent schema format.

At operation 530, the compute node 201 serializes and/or writes the DIO 312 in the destination format 360B from the transformed FILS. In some embodiments, operations 520-530 may take place in a streaming fashion, wherein the parser 221 reads data items from the SIO 311 and uses a streaming API to send the read data items to the serializer 233, which writes the data items to the DIO 312 in a streaming fashion. At operation 535, the compute node 201 sends the DIO 312 to a destination node 307. Process 500 ends at operation 599.

Referring now to FIG. 6, where a process 600 for reading an SIO 311 is shown. Process 600 may correspond to operation 520 of process 500 depicted by FIG. 5. The order of operations(and codec API 240 calls) of process 600 is driven by the order in which logical items appear in the schema 332A(e.g., as represented by the set of DFAs 400, or individual DFAs 405) and answers returned from the codec 352A. The answers returned by the codec 352A will be used by the parser 221 to determine the next question to ask, for example, by consulting individual DFAs 405. In some embodiments, the parser 221 analyzes a logical data structure that an instance of the source format 360A represents(e.g., based on analyzing the source schema 332A) prior to starting process 600.

Process 600 begins at operation 605 where the parser 221 identifies logical items in the source schema 332A for a current data item being analyzed. At operation 605, the parser 221, potentially in coordination with the codec 352A, reads the next data item from the SIO 311 given a logical description of the next data item's content as described by the source schema 332A.

At operation 610, the parser 221, potentially consulting the codec 352A, schema 332A, and/or DFA 405, determines whether a next data item permitted in the instance of the source format 360A occurs(e.g., regardless of whether it is optional, repeatable, or mandatory). Although mandatory items are generally present, this operation gives codec 352A the opportunity to perform specific actions related to the mandatory item and/or provide error detection or recovery when mandatory items are actually missing.

If at operation 610 the parser 221 determines that the next data item does occur(whether optional, repeatable, or mandatory), the parser 221 proceeds to operation 615 to determine whether the next data item is part of a set of mutually exclusive data items permitted next in the instance of the source format 360A. If at operation 610 the parser 221 determines that the next data item does not occur(whether optional, repeatable, or mandatory), the parser 221 proceeds to operation 625 to update the FILS accordingly.

If at operation 615 the parser 221 determines that the next data item is not among a mutually exclusive set of data items, the parser 221 proceeds to operation 625 to update the FILS accordingly. If at operation 615 the parser 221 determines that the next data item is among a mutually exclusive set of data items, the parser 221 proceeds to operation 620 to determine which data item in the set actually occurred. The parser 221 performs this determination by coordinating with the codec 352A. In some implementations, the codec 352A may be able to determine this itself(e.g., by inspecting the SIO 311), or the codec 352A may delegate some or all portions of the determination back to the parser 221 (e.g., if the item has conditional constraint annotations that the parser 221 can evaluate for the code). Additionally or alternatively, when the parser 221 encounters a choice between several mutually exclusive data items, at operation 620 the parser 221 invokes the codec 352A to analyze at the data stream and identify which data item of the choice actually occurs. Based on the understanding of the source format 360A(and knowledge of previously occurring events), the codec 352A is able to identify which data item is actually present. In one example, if the schema 332A indicates that the next data item has a mutually exclusive set of choices available (e.g., operation 615), the parser 221 asks the codec 352A via appropriate code API 240 call(s), which of the possible data items in the choice actually occurred (e.g., operation 620). Based on the answer from the codec 352A(e.g., operation 630), the parser 221 navigates to the next part of the schema 332A and/or DFA 405 (e.g., operation 605) and continues in this manner until process 600 completes. In some embodiments, when process 600 completes, the compute node 201 may return back to process 500 of FIG. 5.

After the FILS is updated at operation 625, the parser 221 proceeds to operation 630 to determine whether there are any more data items in the current item in the schema 332A to analyze, and if so, proceeds back to operation 605. If not, the parser 221 proceeds to end and pops the current DFA 405 off the stack. If there are remaining DFAs 405 on the stack, the compute node 201 resumes processing with the DFA 405 on the top of the stack. The parser 221 continues to ask the codec 352A questions until process 600 completes and there are no more DFAs 405 on the stack, which is when the parser 221 reaches the end of the schema 332A for the SIO 311.

Furthermore, at operations 610 to 620, the parser 221 may also pass metadata to the codec 352A(e.g., annotations, constraints, and/or the like) that goes with the logical items and/or data items so that the codec 352A can perform various computations to determine the answer to be provided back to the parser 221. The particular metadata to be passed to the codec 352A is specific to the codec 352A and varies from embodiment to embodiment. In some embodiments, codec 352A may coordinate with parser 221 to determine the answer it returns. For example, the codec 352A may call a parser API that uses the parser's 221 knowledge of the schema 332A and SIO 311 to evaluate conditional constraint annotations associated with the logical items.

Referring now to FIG. 7, where a process 700 for writing a DIO 312 is shown. Process 700 may correspond to operation 530 of process 500 depicted by FIG. 5. The order of operations(and the particular codec API 240 calls) of process 700 is driven by the order in which data items are provided to the serializer 223 from a host app(e.g., parser 221 or transformer 222) via the FIDD API 210 (e.g., the sequence of events).

Process 700 begins at operation 705 where the serializer 223 receives an event(e.g., data item) from a host app 202 via the FIDD API 210. At operation 710, the serializer 223 determines (e.g., by consulting with the DFA 405) or identifies a transition that matches an input event. If at operation 710 the serializer 223 determines that the transition matches the input event, the serializer 223 proceeds to operation 715 to annotate the list of data items. The transition that matches the input event is annotated with the list of items that “did not occur” prior to the one that “did occur”. The serializer 223 uses this information to issue a series of “occur(false, . . . )” calls to the codec 352B for the items that did not occur, followed by an “occur(true, . . . )” call for the item that actually did occur. This gives the codec 352B an opportunity to update the SIO 311 based on what was and was not included in the message. Similar, to the parsing process of FIG. 6, if the thing (e.g., event or data item) that did occur is a complex type, the serializer 223 will push the current DFA 405 on the stack, fetch the DFA 405 for that complex type and start the process again with the new DFA 405. If the item that did occur is a simple type, the serializer 221 can call a codec API 240 to write the value of that type. When the end of the DFA 405 is reached, the serializer 221 will pop off the stack and resume processing where it left off in the previous DFA 405.

If at operation 710 the serializer 223 determines that the DFA 405 does not have a transition matching the current input event that means it is not allowed here according to the schema 332B. Here, the serializer 223 proceeds to operation 730 to coordinate with the codec 352B to determine how to handle schema deviations(e.g., via an extensibility mechanism) and/or to perform error recovery process(es). In this case, the serializer 221 calls the codec API 240 to determine whether the unexpected item/event “mayOccur” even though the schema 332B says that the unexpected item/event is not allowed. The serializer 221 may also look at what is expected to occur in the schema 332B and use the codec API 240 to ask the codec 352B if it is permitted/acceptable that the expected item/event did not occur(e.g., using “mayOccur(false, . . . )” or the like to effectively represent “mayNotOccur”). The serializer 221 may use some combination of these calls to recover from the error and find a place in the schema 332B where it can continue processing normally. In some implementations, if there are no defined deviation handling mechanisms or error recovery processes, the serializer 221 could end the process 700 at operation 760 (not shown by FIG. 7).

Next, the serializer 223 proceeds to operation 720 to inform the codec 352B of the event/item to be encoded. The serializer 221 knows which of the choices occurred(including mutually exclusive choices that occurred) because it receives which item should be encoded via the FIDD API 210. In some implementations, the serializer 221 calls the choice ( ) method of the codec API 240 to inform the codec 352B which choice was selected. Additionally or alternatively, the serializer 223 can send a ‘did occur’ indicator/event for the next data item to the codec 352B. In either implementation, the choice indication sent to the codec 352B gives the codec 352B an opportunity to write information into the DIO 312 to represent which choice occurred.

After operation 720, the serializer 221 proceeds to operation 725 to determine whether there are any additional events/items, and if not, process 700 ends or returns back to process 500 of FIG. 5. Otherwise, the serializer 221 proceeds back to operation 705 to receive a next event/item. The serializer 223 continues to receive events from the host app 202 (e.g., operation 705) and continues to process the received events until process 700 completes (e.g., when there are no remaining events/items to be processed according to operation 725). When there are no remaining events/data items to be processed(serialized), the serializer 223 proceeds to end and pops the current DFA 405 off the stack. If there are any remaining DFAs 405 on the stack, the compute node 201 resumes processing (serializing) with the next DFA 405 on the top of the stack. The serializer 223 continues to send events/items to the codec 352B until process 700 completes and there are no more DFAs 405 on the stack, which is when the serializer 223 reaches the end of the schema 332B for the DIO 312.

FIG. 8 illustrates an example of a compute node 800 (also referred to as “computing system 800”, “system 800”, “platform 800,” “device 800,” “appliance 800,” “host 800,” “Tactical Data System 800” or “TDS 800,” and/or the like). The compute node 800 may be suitable for use as any of the computer devices discussed herein, such as any of the systems 105-135, a GW 150, compute node 201, KDF processor 220, source node 301, destination node 307, and/or any other computing device/system discussed herein. The components of compute node 800 may be implemented as an individual computer system, or as components otherwise incorporated within a chassis of a larger system. The components of compute node 800 may be implemented as integrated circuits(ICs) or other discrete electronic devices, with the appropriate logic, software, firmware, or a combination thereof, adapted in the compute node 800. Additionally or alternatively, some of the components of compute node 800 may be combined and implemented as a suitable System-on-Chip(SoC), System-in-Package (SiP), multi-chip package (MCP), single-board computer (SBC), and/or the like.

The compute node 800 includes processor circuitry 802, which is configured to execute program code, and/or sequentially and automatically carry out a sequence of arithmetic or logical operations; record, store, and/or transfer digital data. The processor circuitry 802 includes circuitry such as, for example, one or more processor cores and one or more of cache memory, low drop-out voltage regulators(LDOs), interrupt controllers, serial interfaces (e.g., SPI, I2C, universal programmable serial interface circuit, and the like), real time clock(RTC), timer-counters including interval and watchdog timers, general purpose I/O, memory card controllers(e.g., secure digital/multi-media card(SD/MMC) and/or the like), interfaces (e.g., mobile industry processor interface (MIPI) interfaces and Joint Test Access Group(JTAG) test access ports), and/or other like elements. In some implementations, the processor circuitry 802 may include one or more hardware accelerators(not shown), which may include microprocessors, programmable processing devices (e.g., FPGAs, ASICs, and/or the like), or the like. For example, the one or more accelerators may be specifically tailored/designed or programmed/configured to operate the various KDF aspects discussed herein. In some implementations, the processor circuitry 802 may include on-chip memory circuitry, which may include any suitable volatile and/or non-volatile memory, such as DRAM, SRAM, EPROM, EEPROM, Flash memory, solid-state memory, and/or any other type of memory device technology, such as any of those discussed herein, any of those discussed in [′295], and/or those not explicitly described herein. The processor circuitry 802 includes a(micro) architecture that is capable of executing the various aspects and/or techniques discussed herein. The processors(or cores) 802 may be coupled with or may include memory/storage and may be configured to execute instructions stored in the memory/storage to enable various applications or OSs to run on the platform 800. The processors(or cores) 802 is configured to operate application software to provide a specific service to a user of the platform 800. Additionally or alternatively, the processor(s) 802 may be a special-purpose processor(s)/controller (s) configured(or configurable) to operate according to the various embodiments, features, implementations, and examples discussed herein.

The processor(s) of processor circuitry 802 may be or include, for example, one or more processor cores (CPUs), application processors, graphics processing units(GPUs), RISC processors, Acorn RISC Machine (ARM) processors, CISC processors, one or more DSPs, FPGAs, PLDs, one or more ASICs, baseband processors, radio-frequency integrated circuits (RFIC), microprocessors or controllers, multi-core processor, multithreaded processor, ultra-low voltage processor, embedded processor, an xPU(e.g., an MCP including multiple chips stacked like tiles, where the stack of chips includes any of the processor types discussed herein), a data processing unit(DPU), an Infrastructure Processing Unit(IPU), a network processing unit(NPU), and/or any other known processing elements, or any suitable combination thereof. Individual processors(or individual processor cores) of the processor circuitry 802 may be coupled with or may include memory/storage and may be configured to execute instructions stored in the memory/storage to enable various apps or operating systems to run on the compute node 800. In these embodiments, the processors(or cores) of the processor circuitry 802 are configured to operate app software (e.g., KDF 200 of FIGS. 2-7) to provide specific services to a user of the compute node 800.

As examples, the processor circuitry 802 may include an Intel® Architecture Core™ based processor(e.g., i3, an i5, an i7, an i9 based processor(s)); an Intel® microcontroller-based processor(e.g., Quark™, an Atom™, or other MCU-based processor); Pentium® processor(s), Xeon® processor(s), and/or another such processor available from Intel® Corporation, Santa Clara, California; one or more of Advanced Micro Devices (AMD) Zen® Architecture (e.g., Ryzen® or EPYC® processor(s), Accelerated Processing Units(APUs), MxGPUs, Epyc® processor(s), or the like); A5-A12 and/or S1-S4 processor(s) from Apple® Inc.; Snapdragon™ or Centriq™ processor(s) from Qualcomm® Technologies, Inc.; Texas Instruments, Inc.@ Open Multimedia Applications Platform(OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor circuitry 802 may be a part of an SoC, SiP, MCP, SBC, or other package or IC. Other examples of the processor circuitry 802 may be mentioned elsewhere in the present disclosure.

In some implementations, such as when compute node 800 is(or is part of) a server computer system, the processor circuitry 802 may include one or more hardware accelerators. The hardware accelerators may be microprocessors, configurable hardware (e.g., field-programmable gate arrays(FPGAs), programmable Application Specific Integrated Circuits (ASICs), programmable SoCs, digital signal processors(DSP), and/or the like), or some other suitable special-purpose processing device tailored to perform one or more specific tasks. The hardware accelerators may be hardware devices that perform various functions that may be offloaded from an one or more processors of the processor circuitry 802. In these embodiments, the circuitry of processor circuitry 802 may comprise logic blocks or logic fabric including and other interconnected resources that may be programmed to perform various functions, such as the procedures, methods, functions, and/or the like. of the various embodiments discussed herein. Additionally, the processor circuitry 802 may include memory cells(e.g., EPROM, EEPROM, flash memory, static memory(e.g., SRAM, anti-fuses, and/or the like) used to store logic blocks, logic fabric, data, and/or the like. in LUTs and the like. In embodiments where subsystems of the compute node 800 (e.g., KDF processor 220 shown and described with respect FIGS. 2-7) are implemented as individual software agents or AI agents, each agent may be implemented in a respective hardware accelerator that are configured with appropriate bit stream(s) or logic blocks to perform their respective functions

In some implementations, processor(s) and/or hardware accelerators of the application circuitry 802 may be specifically tailored for operating the software (AI) agents and/or for machine learning functionality, such as a cluster of AI GPUs, tensor processing units(TPUs) developed by Google® Inc., a Real AI Processors(RAPS™) provided by AlphalCs®, Nervana™ Neural Network Processors(NNPs) provided by Intel® Corp., Intel® Movidius™ Myriad™ X Vision Processing Unit(VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the hardware accelerator may be implemented as an AI accelerating co-processor, such as the Hexagon 685 DSP provided by Qualcomm®, the PowerVR 2NX Neural Net Accelerator(NNA) provided by Imagination Technologies Limited®, the Neural Engine core within the Apple® A11 or A12 Bionic SoC, the Neural Processing Unit within the HiSilicon Kirin 970 provided by Huawei®, and/or the like.

The memory circuitry 804 comprises any number of memory devices arranged to provide primary storage from which the processor circuitry 802 continuously reads instructions 882 stored therein for execution. In some embodiments, the memory circuitry 804 is on-die memory or registers associated with the processor circuitry 802. As examples, the memory circuitry 804 may include volatile memory such as random access memory(RAM), dynamic RAM(DRAM), synchronous DRAM(SDRAM), and/or the like. The memory circuitry 804 may also include nonvolatile memory(NVM) such as high-speed electrically erasable memory(commonly referred to as “flash memory”), phase change RAM(PRAM), resistive memory such as magnetoresistive random access memory(MRAM), and/or the like. The memory circuitry 804 may also comprise persistent storage devices, which may be temporal and/or persistent storage of any type, including, but not limited to, non-volatile memory, optical, magnetic, and/or solid state mass storage, and so forth.

Storage circuitry 808 is arranged to provide persistent storage of information such as data, apps, operating systems(OS), and so forth. As examples, the storage circuitry 808 may be implemented as hard disk drive (HDD), a micro HDD, a solid-state disk drive (SSDD), flash memory cards(e.g., SD cards, microSD cards, extreme Digital(XD) picture cards, and the like), USB flash drives, and the like.

Additionally or alternatively, the memory circuitry 804 and/or storage circuitry 808 may be, or may include one or more of the following memory/storage technologies: memory devices that use chalcogenide glass, multi-threshold level NAND flash memory, NOR flash memory, single or multi-level Phase Change Memory(PCM) and/or phase change memory with a switch (PCMS), NVM devices that use chalcogenide phase change material(e.g., chalcogenide glass), a resistive memory, nanowire memory, ferroelectric transistor random access memory(FeTRAM), anti-ferroelectric memory, magnetoresistive random access memory(MRAM) memory that incorporates memristor technology, phase change RAM(PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction(MTJ) based device, a domain wall(DW) and spin orbit transfer (SOT) based device, a thyristor based memory device, or a combination of any of the above, or other memory. Additionally or alternatively, the memory circuitry 804 and/or storage circuitry 808 can include resistor-based and/or transistor-less memory architectures. The memory circuitry 804 and/or storage circuitry 808 may also incorporate three-dimensional(3D) cross-point (xPoint) memory devices, and/or other byte addressable write-in-place NVM. In some implementations(e.g., low power devices or the like), the storage 808 may be or include on-die memory or registers associated with the processor 802. Furthermore, any number of new technologies may be used for the memory 804 and/or storage 808 in addition to, or instead of, the technologies described herein such as, for example, resistance change memories, phase change memories, holographic memories, or chemical memories, among others. The memory circuitry 804 and/or storage circuitry 808 may refer to the die itself and/or to a packaged memory product. In some implementations, the storage circuitry 808 and/or memory circuitry 804 may be disposed in or on a same die or package as the processor circuitry 802 (e.g., a same SoC, a same SiP, or soldered on a same MCP as the processor circuitry 802).

The storage circuitry 808 is configured to store computational logic 883 (or “modules 883”) in the form of software, firmware, middleware, microcode, hardware-level instructions, or the like, to implement the various aspects and techniques described herein. The computational logic 883 may be employed to store working copies and/or permanent copies of programming instructions for the operation of various components of compute node 800 (e.g., drivers, libraries, application programming interfaces (APIs), and/or the like), an OS of compute node 800, one or more apps, and/or for carrying out the embodiments discussed herein(such as one or more operations of processes 500-700 of FIGS. 5-7). The computational logic 883 may be stored or loaded into memory circuitry 804 as instructions 882, which are then accessed for execution by the processor circuitry 802 to carry out the functions described herein. The various elements may be implemented by assembler instructions supported by processor circuitry 802 or high-level languages that may be compiled into instructions 881 to be executed by the processor circuitry 802. The permanent copy of the programming instructions may be placed into persistent storage devices of storage circuitry 808 in the factory or in the field through, for example, a distribution medium(not shown), through a communication interface (e.g., from a distribution server (not shown)), or over-the-air(OTA).

In an example, the instructions 882 provided via the memory circuitry 804 and/or the storage circuitry 808 of FIG. 8 are embodied as one or more non-transitory computer readable storage media(see e.g., NTCRSM 860) including program code, a computer program product or data to create the computer program, with the computer program or data, to direct the processor circuitry 802 of platform 800 to perform electronic operations in the platform 800, and/or to perform a specific sequence or flow of actions, for example, as described with respect to the flowchart(s) and block diagram(s) of operations and functionality depicted previously. The processor circuitry 802 accesses the one or more non-transitory computer readable storage media over the IX 806.

In alternate embodiments, programming instructions(or data to create the instructions) may be disposed on multiple NTCRSM 860. In alternate embodiments, programming instructions (or data to create the instructions) may be disposed on computer-readable transitory storage media, such as, signals. The instructions embodied by a machine-readable medium may further be transmitted or received over a communications network using a transmission medium via a network interface device utilizing any one of a number of transfer protocols(e.g., HTTP). Any combination of one or more computer usable or computer readable medium(s) may be utilized. The computer-usable or computer-readable medium may be, for example but not limited to, one or more electronic, magnetic, optical, electromagnetic, infrared, or semiconductor systems, apparatuses, devices, or propagation media. For instance, the NTCRSM 860 may be embodied by devices described for the storage circuitry 808 and/or memory circuitry 804. More specific examples (a non-exhaustive list) of a computer-readable medium would include the following: an electrical connection having one or more wires, a portable computer diskette, a hard disk, a random access memory(RAM), a read-only memory(ROM), an erasable programmable read-only memory(EPROM, Flash memory, and/or the like), an optical fiber, a portable compact disc read-only memory(CD-ROM), an optical storage device and/or optical disks, a transmission media such as those supporting the Internet or an intranet, a magnetic storage device, or any number of other hardware devices. Note that the computer-usable or computer-readable medium could even be paper or another suitable medium upon which the program(or data to create the program) is printed, as the program(or data to create the program) can be electronically captured, via, for instance, optical scanning of the paper or other medium, then compiled, interpreted, or otherwise processed in a suitable manner, if necessary, and then stored in a computer memory (with or without having been staged in or more intermediate storage media). In the context of this document, a computer-usable or computer-readable medium may be any medium that can contain, store, communicate, propagate, or transport the program(or data to create the program) for use by or in connection with the instruction execution system, apparatus, or device. The computer-usable medium may include a propagated data signal with the computer-usable program code (or data to create the program code) embodied therewith, either in baseband or as part of a carrier wave. The computer usable program code (or data to create the program) may be transmitted using any appropriate medium, including but not limited to wireless, wireline, optical fiber cable, RF, and/or the like.

In various embodiments, the program code (or data to create the program code) described herein may be stored in one or more of a compressed format, an encrypted format, a fragmented format, a packaged format, and/or the like. Program code (or data to create the program code) as described herein may require one or more of installation, modification, adaptation, updating, combining, supplementing, configuring, decryption, decompression, unpacking, distribution, reassignment, and/or the like. in order to make them directly readable and/or executable by a computing device and/or other machine. For example, the program code (or data to create the program code) may be stored in multiple parts, which are individually compressed, encrypted, and stored on separate computing devices, wherein the parts when decrypted, decompressed, and combined form a set of executable instructions that implement the program code (the data to create the program code such as that described herein. In another example, the Program code (or data to create the program code) may be stored in a state in which they may be read by a computer, but require addition of a library(e.g., a dynamic link library), a software development kit(SDK), an API, web service, and the like in order to execute the instructions on a particular computing device or other device. In another example, the program code (or data to create the program code) may need to be configured(e.g., settings stored, data input, network addresses recorded, and/or the like) before the program code (or data to create the program code) can be executed/used in whole or in part. In this example, the program code (or data to create the program code) may be unpacked, configured for proper execution, and stored in a first location with the configuration instructions located in a second location distinct from the first location. The configuration instructions can be initiated by an action, trigger, or instruction that is not co-located in storage or execution location with the instructions enabling the disclosed techniques. Accordingly, the disclosed program code (or data to create the program code) are intended to encompass such machine readable instructions and/or program(s)(or data to create such machine readable instruction and/or programs) regardless of the particular format or state of the machine readable instructions and/or program(s) when stored or otherwise at rest or in transit.

Computer program code for carrying out operations of the present disclosure (e.g., computational logic 883, instructions 882, 881 discussed previously) may be written in any combination of one or more programming languages such as, for example, Python, PyTorch, NumPy, Ruby, Ruby on Rails, Scala, Smalltalk, Java™, C++, C#, “C”, Rust, Go(or “Golang”), JavaScript, Server-Side JavaScript(SSJS), PHP, Pearl, Lua, Torch/Lua with Just-In Time compiler (LuaJIT), Accelerated Mobile Pages Script(AMPscript), VBScript, JavaServer Pages (JSP), Active Server Pages (ASP), Node.js, ASP.NET, JAMscript, Hypertext Markup Language (HTML), XML, EXI, XSL, XSD, wiki markup or Wikitext, Wireless Markup Language (WML), JSON, Apache® MessagePack™, Cascading Stylesheets(CSS), Mustache template language, Handlebars template language, Guide Template Language (GTL), Apache® Thrift, ASN.1, protobuf, Android® Studio™ integrated development environment(IDE), Apple® iOS® software development kit(SDK), and/or any other programming language or development tools including proprietary programming languages and/or development tools. The computer program code for carrying out operations of the present disclosure may also be written in any combination of the programming languages discussed herein. The program code may execute entirely on the compute node 800, partly on the compute node 800, as a stand-alone software package, partly on the compute node 800 and partly on a remote computer or entirely on the remote computer or server. In the latter scenario, the remote computer may be connected to the compute node 800 through any type of network, including a LAN or WAN, or the connection may be made to an external computer (e.g., through the Internet using an Internet Service Provider).

In an example, the instructions 881 on the processor circuitry 802 (separately, or in combination with the instructions 882 and/or logic/modules 883 stored in computer-readable storage media) may configure execution or operation of a trusted execution environment(TEE) 890. The TEE 890 operates as a protected area accessible to the processor circuitry 802 to enable secure access to data and secure execution of instructions. In some embodiments, the TEE 890 may be a physical hardware device that is separate from other components of the compute node 800 such as a secure-embedded controller, a dedicated SoC, or a tamper-resistant chipset or microcontroller with embedded processing devices and memory devices. Examples of such embodiments include a Desktop and mobile Architecture Hardware (DASH) compliant Network Interface Card(NIC), Intel® Management/Manageability Engine, Intel® Converged Security Engine (CSE) or a Converged Security Management/Manageability Engine (CSME), Trusted Execution Engine (TXE) provided by Intel® each of which may operate in conjunction with Intel® Active Management Technology(AMT) and/or Intel® vPro™ Technology; AMD® Platform Security coProcessor(PSP), AMD® PRO A-Series Accelerated Processing Unit(APU) with DASH manageability, Apple® Secure Enclave coprocessor; IBM® Crypto Express3®, IBM® 4807, 4808, 4809, and/or 4765 Cryptographic Coprocessors, IBM® Baseboard Management Controller (BMC) with Intelligent Platform Management Interface (IPMI), Dell™ Remote Assistant Card II(DRAC II), integrated Dell™ Remote Assistant Card(iDRAC), and the like.

In other embodiments, the TEE 890 may be implemented as secure enclaves, which are isolated regions of code and/or data within the processor and/or memory/storage circuitry of the compute node 800. Only code executed within a secure enclave may access data within the same secure enclave, and the secure enclave may only be accessible using the secure app(which may be implemented by an app processor or a tamper-resistant microcontroller). Various implementations of the TEE 890, and an accompanying secure area in the processor circuitry 802 or the memory circuitry 804 and/or storage circuitry 808 may be provided, for instance, through use of Intel® Software Guard Extensions(SGX), ARM® TrustZone® hardware security extensions, Keystone Enclaves provided by Oasis Labs™, and/or the like. Other aspects of security hardening, hardware roots-of-trust, and trusted or protected operations may be implemented in the device 800 through the TEE 890 and the processor circuitry 802.

Although the instructions 881, 882 are shown as code blocks included in the memory circuitry 804 and processor circuitry 802, and the computational logic 883 is shown as code blocks in the storage circuitry 808, any of the code blocks may be replaced with hardwired circuits, for example, built into a PLD(e.g., FPGA, ASIC), or some other suitable circuitry. For example, where processor circuitry 802 includes (e.g., FPGA based) hardware accelerators as well as processor cores, the hardware accelerators(e.g., the FPGA cells) may be pre-configured(e.g., with appropriate bit streams) with the aforementioned computational logic 883 to perform some or all of the functions discussed previously(in lieu of employment of programming instructions to be executed by the processor core (s) 802).

The operating system(OS) of compute node 800 may be a general purpose OS or an OS specifically written for and tailored to the compute node 800. For example, when the compute node 800 is a server system or a desktop or laptop systems 105-135, the OS may be Unix or a Unix-like OS such as Linux e.g., provided by Red Hat Enterprise, Windows 10™ provided by Microsoft Corp., macOS provided by Apple Inc.®, or the like. In another example where the compute node 800 is a mobile device, the OS may be a mobile OS, such as Android® provided by Google Inc., iOS® provided by Apple Inc., Windows 10 Mobile® provided by Microsoft Corp., KaiOS provided by KaiOS Technologies Inc., or the like. The OS manages computer hardware and software resources, and provides common services for various apps(e.g., app(s) 202, KDF 200, and/or the like). The OS may include one or more drivers or APIs that operate to control particular devices that are embedded in the compute node 800, attached to the compute node 800, or otherwise communicatively coupled with the compute node 800. The drivers may include individual drivers allowing other components of the compute node 800 to interact or control various I/O devices that may be present within, or connected to, the compute node 800. For example, the drivers may include a display driver to control and allow access to a display device, a touchscreen driver to control and allow access to a touchscreen interface of the compute node 800, sensor drivers to obtain sensor readings of sensor circuitry 821 and control and allow access to sensor circuitry 821, actuator drivers to obtain actuator positions of the actuators 822 and/or control and allow access to the actuators 822, a camera driver to control and allow access to an embedded image capture device, audio drivers to control and allow access to one or more audio devices. The OSs may also include one or more libraries, drivers, APIs, firmware, middleware, software glue, and/or the like, which provide program code and/or software components for one or more apps to obtain and use the data from other apps operated by the compute node 800.

In an example, the instructions 882 provided via the memory circuitry 804 and/or the storage circuitry 808 are embodied as a non-transitory, machine-readable medium S60 including code to direct the processor circuitry 802 to perform electronic operations in the compute node 800. The processor circuitry 802 accesses the non-transitory machine-readable medium 860 over the IX 806. For instance, the non-transitory, machine-readable medium 860 may be embodied by devices described for the storage circuitry 808 of FIG. 8 or may include specific storage units such as optical disks, flash drives, or any number of other hardware devices. The non-transitory, machine-readable medium 860 may include instructions 882 to direct the processor circuitry 802 to perform a specific sequence or flow of actions, for example, as described with respect to the flowchart(s) and block diagram(s) of operations and functionality depicted previously(see e.g., FIGS. 2-7). In further examples, a machine-readable medium 860 also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include, but is not limited to, solid-state memories, and optical and magnetic media. Specific examples of machine-readable media include non-volatile memory, including but not limited to, by way of example, semiconductor memory devices (e.g., EPROM, EEPROM) and flash memory devices; magnetic disks such as internal hard disks and removable disks; magneto-optical disks; and CD-ROM and DVD-ROM disks. The instructions embodied by a machine-readable medium 860 may further be transmitted or received over a communications network using a transmission medium via a network interface device utilizing any one of a number of transfer protocols(e.g., HTTP). In alternate embodiments, the programming instructions may be disposed on multiple computer-readable non-transitory storage media instead. In still other embodiments, the programming instructions may be disposed on computer-readable transitory storage media, such as, signals.

The components of compute node 800 communicate with one another over the interconnect (IX) 806. The IX 806 may represent any suitable type of connection or interface such as, for example, metal or metal alloys(e.g., copper, aluminum, and/or the like), fiber, and/or the like. The IX 806 may include any number of IX, fabric, and/or interface technologies, including instruction set architecture (ISA), extended ISA(elSA), inter-integrated circuit(I2C), serial peripheral interface (SPI), point-to-point interfaces, power management bus(PMBus), peripheral component interconnect (PCI), PCI express(PCIe), PCI extended(PCIx), Intel® Ultra Path Interconnect (UPI), Intel® Accelerator Link, Intel® QuickPath Interconnect (QPI), Intel® Omni-Path Architecture (OPA), Compute Express Link™ (CXL™) IX technology, RapidIO™ IX, Coherent Accelerator Processor Interface (CAPI), OpenCAPI, cache coherent interconnect for accelerators(CCIX), Gen-Z Consortium IXs, HyperTransport IXs, NVLink provided by NVIDIA®, a Time-Trigger Protocol(TTP) system, a FlexRay system, PROFIBUS, ARM® Advanced extensible Interface (AXI), ARM® Advanced Microcontroller Bus Architecture (AMBA) IX, HyperTransport, Infinity Fabric(IF), Aeronautical Radio Inc. (ARINC) 429, ARINC 629 (“Digital Autonomous Terminal Access Communication”), ARINC 653 (“Avionics Application Standard Software Interface”, “Application Executive” or “APEX”), and/or any number of other IX technologies. The IX 806 may be a proprietary bus, for example, used in an SoC based system or the like.

The communication circuitry 809 is a hardware element, or collection of hardware elements, used to communicate over one or more networks(e.g., network 899) and/or with other devices. The communication circuitry 809 includes modem 810 and transceiver circuitry(“TRx”) 812. The modem 810 includes one or more processing devices (e.g., baseband processors) to carry out various protocol and radio control functions. Modem 810 may interface with app circuitry of compute node 800 (e.g., a combination of processor circuitry 802 and CRM 860) for generation and processing of baseband signals and for controlling operations of the TRx 812. The modem 810 may handle various radio control functions that enable communication with one or more radio networks via the TRx 812 according to one or more wireless communication protocols. The modem 810 may include circuitry such as, but not limited to, one or more single-core or multi-core processors(e.g., one or more baseband processors) or control logic to process baseband signals received from a receive signal path of the TRx 812, and to generate baseband signals to be provided to the TRx 812 via a transmit signal path. In various embodiments, the modem 810 may implement a real-time OS(RTOS) to manage resources of the modem 810, schedule tasks, and/or the like.

The communication circuitry 809 also includes TRx 812 to enable communication with wireless networks using modulated electromagnetic radiation through a non-solid medium. TRx 812 includes a receive signal path, which comprises circuitry to convert analog RF signals(e.g., an existing or received modulated waveform) into digital baseband signals to be provided to the modem 810. The TRx 812 also includes a transmit signal path, which comprises circuitry configured to convert digital baseband signals provided by the modem 810 to be converted into analog RF signals(e.g., modulated waveform) that will be amplified and transmitted via an antenna array including one or more antenna elements(not shown). The antenna array may be a plurality of microstrip antennas or printed antennas that are fabricated on the surface of one or more printed circuit boards. The antenna array may be formed in as a patch of metal foil(e.g., a patch antenna) in a variety of shapes, and may be coupled with the TRx 812 using metal transmission lines or the like. The TRx 812 may include one or more radios that are compatible with, and/or may operate according to any one or more of the radio communication technologies and/or standards, such as those discussed herein.

Network interface circuitry/controller (NIC) 816 provides wired communication to the network 850 and/or to other devices using a standard communication protocol such as, for example, Ethernet, Ethernet over GRE Tunnels, Ethernet over Multiprotocol Label Switching (MPLS), Ethernet over USB, Controller Area Network (CAN), Local Interconnect Network (LIN), DeviceNet, ControlNet, Data Highway+, PROFIBUS, or PROFINET, among many others, including any of those discussed herein, any of those discussed in [′295], and/or those not explicitly described herein. Network connectivity may be provided to/from the compute node 800 via the NIC 816 using a physical connection, which may be electrical(e.g., a “copper interconnect”), fiber, and/or optical. The physical connection also includes suitable input connectors(e.g., ports, receptacles, sockets, and the like) and output connectors(e.g., plugs, pins, and the like). The NIC 816 may include one or more dedicated processors and/or FPGAs to communicate using one or more of the aforementioned network interface protocols. In some implementations, the NIC 816 may include multiple controllers to provide connectivity to other networks using the same or different protocols. For example, the compute node 800 may include a first NIC 816 providing communications to the network 850 over Ethernet and a second NIC 816 providing communications to other devices over another type of network. As examples, the NIC 816 is or includes one or more of an Ethernet controller (e.g., a Gigabit Ethernet Controller or the like), a high-speed serial interface (HSSI), a Peripheral Component Interconnect (PCI) controller, a USB controller, a SmartNIC, an Intelligent Fabric Processor(IFP), and/or other like device (s).

The network 850 includes computers, network connections among various computers (e.g., between the compute node 800 and remote system 845), and software routines to enable communication between the computers over respective network connections. In this regard, the network 850 comprises one or more network elements that may include one or more processors, communications systems(e.g., including network interface controllers, one or more transmitters/receivers connected to one or more antennas, and the like), and computer readable media. Examples of such network elements may include wireless access points(WAPs), a home/business/enterprise server (with or without radio frequency(RF) communications circuitry), a router, a switch, a hub, a radio beacon, base stations, picocell or small cell base stations, and/or any other like network device. Connection to the network 850 may be via a wired or a wireless connection using the various communication protocols discussed herein. More than one network may be involved in a communication session between the various devices. Connection to the network 850 may require that the computers execute software routines which enable, for example, the seven layers of the OSI model of computer networking or equivalent in a wireless(or cellular) phone network. Additionally or alternatively, the network 850 may correspond to the cloud in FIG. 1 and/or any other network (s) and/or service (s) discussed herein.

The remote system 845 (also referred to as a “service provider”, “application server (s)”, “app server (s)”, “external platform”, and/or the like) comprises one or more physical and/or virtualized computing systems owned and/or operated by a company, enterprise, and/or individual that hosts, serves, and/or otherwise provides InOb(s) to one or more users(e.g., compute node 800). The physical and/or virtualized systems include one or more logically or physically connected servers and/or data storage devices distributed locally or across one or more geographic locations. Generally, the remote system 845 uses IP/network resources to provide InOb(s) such as electronic documents, webpages, forms, apps(e.g., native apps, web apps, mobile apps, and/or the like), data, services, web services, media, and/or content to different user/client devices. As examples, the service provider 845 may provide mapping and/or navigation services; cloud computing services (e.g., cloud computing services provided by cloud service provider 135 in FIG. 1 or the like); search engine services; social networking, microblogging, and/or message board services; content(media) streaming services; e-commerce services; blockchain services; communication services such as Voice-over-Internet Protocol (VOIP) sessions, text messaging, group communication sessions, and the like; immersive gaming experiences; data translation/transformation services; and/or other like services. The user/client devices that utilize services provided by remote system 845 may be referred to as “subscribers” or the like. In one example, the compute node 800 corresponds to one of the systems 105-135, and the remote system 845 corresponds to a different one of the systems 105-135. In another example, the compute node 800 corresponds to source node 301 and the remote system 845 corresponds to destination node 307. In another example, the compute node 800 corresponds to source node 301 that also includes the KDF processor 220, and the remote system 845 corresponds to destination node 307. In another example, the compute node 800 corresponds to source node 301, and the remote system 845 corresponds to destination node 307 that includes the KDF processor 220. Additional or alternative combinations are also possible. Although FIG. 8 shows only a single remote system 845, the remote system 845 may represent multiple remote system 845.

The interface circuitry 818 is configured to connect or communicatively coupled the compute node 800 with one or more external(peripheral) components, devices, and/or subsystems. In some implementations, the interface circuitry 818 may be used to transfer data between the compute node 800 and another computer device (e.g., remote system 845, a laptop, a smartphone, or some other user device) via a wired and/or wireless connection. As examples, the interface circuitry 818 can be embodied as an expansion bus, peripheral card, host bus adapters, and/or mezzanine. In some implementations, the interface circuitry 818 includes one or more interface controllers and connectors that interconnect one or more of the processor circuitry 802, memory circuitry 804, storage circuitry 808, communication circuitry 809, and the other components of compute node 800 and/or to one or more external(peripheral) components, devices, and/or subsystems. As examples, the interface controllers include memory controllers, storage controllers(e.g., redundant array of independent disk(RAID) controllers and the like), baseboard management controllers(BMCs), input/output(I/O) controllers, host controllers, and the like. Examples of I/O controllers include integrated memory controller (IMC), memory management unit(MMU), input-output MMU(IOMMU), sensor hub, General Purpose I/O(GPIO) controller, PCIe endpoint(EP) device, direct media interface (DMI) controller, Intel® Flexible Display Interface (FDI) controller (s), VGA interface controller (s), Peripheral Component Interconnect Express(PCIe) controller (s), universal serial bus(USB) controller (s), FireWire controller (s), Thunderbolt controller (s), FPGA Mezzanine Card(FMC), extensible Host Controller Interface (xHCI) controller (s), Enhanced Host Controller Interface (EHCI) controller (s), Serial Peripheral Interface (SPI) controller (s), Direct Memory Access(DMA) controller (s), hard drive controllers(e.g., Serial AT Attachment(SATA) host bus adapters/controllers, Intel® Rapid Storage Technology(RST), and/or the like), Advanced Host Controller Interface (AHCI), a Low Pin Count(LPC) interface (bridge function), Advanced Programmable Interrupt Controller (s) (APIC), audio controller (s), SMBus host interface controller (s), UART controller (s), and/or the like. Some of these controllers may be part of, or otherwise applicable to the memory circuitry 804, storage circuitry 808, and/or IX 806 as well. As examples, the connectors include electrical connectors, ports, slots, jumpers, receptacles, modular connectors, coaxial cable and/or BNC connectors, optical fiber connectors, PCB mount connectors, inline/cable connectors, chassis/panel connectors, peripheral component interfaces (e.g., non-volatile memory ports, USB ports, Ethernet ports, audio jacks, power supply interfaces, on-board diagnostic(OBD) ports, and so forth), and/or the like. The external devices include, inter alia, sensor circuitry 821, actuator circuitry 822, positioning circuitry 825, and I/O devices 840, but may also include other devices or subsystems not shown by FIG. 8.

The sensor circuitry 821 includes devices, modules, or subsystems whose purpose is to detect events or changes in its environment and send the information(sensor data) about the detected events to some other device, module, subsystem, and the like. Examples of such sensors 821 include, inter alia, inertia measurement units(IMU) comprising accelerometers, gyroscopes, and/or magnetometers; microelectromechanical systems(MEMS) or nanoelectromechanical systems(NEMS) comprising 3-axis accelerometers, 3-axis gyroscopes, and/or magnetometers; level sensors; flow sensors; temperature sensors(e.g., thermistors); pressure sensors; barometric pressure sensors; gravimeters; altimeters; image capture devices (e.g., visible-light cameras, infrared-light cameras, and/or the like); light detection and ranging (LiDAR) sensors; proximity sensors(e.g., infrared radiation detector and the like), depth sensors, ambient light sensors, ultrasonic transceivers; microphones; and the like. Additional or alternative sensors 821 can be included based on implementation and/or use case.

The actuators 822 allow compute node 800 to change its state, position, and/or orientation, or move or control a mechanism or system. The actuators 822 comprise electrical and/or mechanical devices for moving or controlling a mechanism or system, and converts energy(e.g., electric current or moving air and/or liquid) into some kind of motion. The compute node 800 may be configured to operate one or more actuators 822 based on one or more captured events, instructions, control signals, and/or configurations received from a service provider 845, one or more systems 105-135, and/or other components of the compute node 800. Additionally or alternatively, the actuators 822 are used to change the operational state (e.g., on/off, zoom or focus, and/or the like), position, and/or orientation of the sensors 821. As examples, the actuators 822 can be or include any number and combination of the following: soft actuators(e.g., actuators that changes its shape in response to a stimuli such as, for example, mechanical, thermal, magnetic, and/or electrical stimuli), hydraulic actuators, pneumatic actuators, mechanical actuators, electromechanical actuators(EMAs), microelectromechanical actuators, electrohydraulic actuators, linear actuators, linear motors, rotary motors, DC motors, stepper motors, servomechanisms, electromechanical switches, electromechanical relays(EMRs), power switches, valve actuators, piezoelectric actuators and/or biomorphs, thermal biomorphs, solid state actuators, solid state relays(SSRs), shape-memory alloy-based actuators, electroactive polymer-based actuators, relay driver integrated circuits(ICs), solenoids, impactive actuators/mechanisms(e.g., jaws, claws, tweezers, clamps, hooks, mechanical fingers, humaniform dexterous robotic hands, and/or other gripper mechanisms that physically grasp by direct impact upon an object), propulsion actuators/mechanisms(e.g., wheels, axles, thrusters, propellers, engines, motors(e.g., those discussed previously), clutches, and the like), projectile actuators/mechanisms(e.g., mechanisms that shoot or propel objects or elements), and/or audible sound generators, visual warning devices, and/or other like electromechanical components. Additionally or alternatively, the actuators 822 can include virtual instrumentation and/or virtualized actuator devices. Additional or alternative actuators 822 can be included based on implementation and/or use case. Additionally or alternatively, the actuators 822 can include various controller and/or components of the compute node 800 (or components thereof) such as, for example, host controllers, cooling element controllers, baseboard management controller (BMC), platform controller hub(PCH), uncore components(e.g., shared last level cache (LLC) cache, caching agent(Cbo), integrated memory controller (IMC), home agent(HA), power control unit(PCU), configuration agent(Ubox), integrated I/O controller (IIO), and interconnect (IX) link interfaces and/or controllers), and/or any other components such as any of those discussed herein, any of those discussed in [′295], and/or those not explicitly described herein.

The positioning circuitry(POS) 825 includes circuitry to receive and decode signals transmitted/broadcasted by a positioning network of a navigation satellite system(NSS). An NSS provides autonomous geo-spatial positioning with global or regional coverage. Augmentation systems are NSS that provide regional coverage to augment the navigation systems with global coverage. For purposes of the present disclosure, the term “NSS” may encompass or refer to global, regional, and/or augmentation satellite systems. Examples of NSS include global NSS (GNSS)(e.g., Global Positioning System(GPS), the European Union's Galileo system, Russia's Global Navigation System(GLONASS), China's BeiDou NSS(BDS), and/or the like), regional NSS(e.g., Indian Regional Navigation Satellite System(IRNSS) or Navigation with Indian Constellation(NavIC), Japan's Quasi-Zenith Satellite System(QZSS), France's Doppler Orbitography and Radio-positioning Integrated by Satellite (DORIS), and/or the like), Space Based Augmentation System(SBAS)(e.g., Wide Area Augmentation System(WAAS), European Geostationary Navigation Overlay Service (EGNOS), Multi-Functional Satellite Augmentation System(MSAS), GPS Aided Geo Augmented Navigation(GAGAN), or the like. The PoS 825 comprises various hardware elements(e.g., including hardware devices such as switches, filters, amplifiers, antenna elements, and the like to facilitate OTA communications) to communicate with components of a positioning network, such as navigation satellite constellation nodes. Additionally or alternatively, the PoS 825 may include a Micro-Technology for Positioning, Navigation, and Timing (Micro-PNT) IC that uses a master timing clock to perform position tracking/estimation without GNSS assistance. The PoS 825 may also be part of, or interact with, the communication circuitry 809 to communicate with the nodes and components of the positioning network. The PoS 825 may also provide position data and/or time data to the application circuitry, which may use the data to synchronize operations with various infrastructure (e.g., radio base stations), for turn-by-turn navigation, or the like. When a GNSS signal is not available or when GNSS position accuracy is not sufficient for a particular application or service, a positioning augmentation technology can be used to provide augmented positioning information and data to the application or service. Such a positioning augmentation technology may include, for example, satellite based positioning augmentation(e.g., EGNOS) and/or ground based positioning augmentation(e.g., DGPS). In some implementations, the PoS 825 is, or includes an INS, which is a system or device that uses sensor circuitry 821 (e.g., motion sensors such as accelerometers, rotation sensors such as gyroscopes, and altimeters, magnetic sensors, and/or the like to continuously calculate (e.g., using dead by dead reckoning, triangulation, or the like) a position, orientation, and/or velocity(including direction and speed of movement) of the platform 800 without the need for external references.

In some examples, various input/output(I/O) devices 840 may be present within and/or connected to, the compute node 800, which are referred to as input circuitry and output circuitry. The input circuitry and output circuitry include one or more user interfaces designed to enable user interaction with the platform 800 and/or peripheral component interfaces designed to enable peripheral component interaction with the platform 800. Input circuitry may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry may be included to show information or otherwise convey information, such as sensor readings, actuator position(s), or other like information. Data and/or graphics may be displayed on one or more user interface components of the output circuitry. Output circuitry may include any number and/or combinations of audio or visual display, including, inter alia, one or more simple visual outputs/indicators(e.g., binary status indicators(e.g., light emitting diodes (LEDs)) and multi-character visual outputs, or more complex outputs such as display devices or touchscreens(e.g., Liquid Chrystal Displays(LCD), LED displays, quantum dot displays, projectors, and/or the like), with the output of characters, graphics, multimedia objects, and the like being generated or produced from the operation of the platform 800. The output circuitry may also include speakers or other audio emitting devices, printer (s), and/or the like. Additionally or alternatively, the sensor circuitry 821 may be used as the input circuitry(e.g., an image capture device, motion capture device, or the like) and one or more actuators 822 may be used as the output device circuitry(e.g., an actuator to provide haptic feedback or the like). In another example, near-field communication(NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, and/or the like.

A battery 824 may be coupled to the compute node 800 to power the compute node 800, which may be used in embodiments where the compute node 800 is not in a fixed location, such as when the compute node 800 is a mobile or laptop systems 105-135. The battery 824 may be a lithium ion battery, a lead-acid automotive battery, or a metal-air battery, such as a zinc-air battery, an aluminum-air battery, a lithium-air battery, a lithium polymer battery, and/or the like. In embodiments where the compute node 800 is mounted in a fixed location, such as when the system is implemented as a server computer system, the compute node 800 may have a power supply coupled to an electrical grid. In these embodiments, the compute node 800 may include power tee circuitry to provide for electrical power drawn from a network cable to provide both power supply and data connectivity to the compute node 800 using a single cable.

Power management integrated circuitry(PMIC) 826 may be included in the compute node 800 to track the state of charge (SoCh) of the battery 824, and to control charging of the compute node 800. The PMIC 826 may be used to monitor other parameters of the battery 824 to provide failure predictions, such as the state of health (SoH) and the state of function(SoF) of the battery 824. The PMIC 826 may include voltage regulators, surge protectors, power alarm detection circuitry. The power alarm detection circuitry may detect one or more of brown out(under-voltage) and surge (over-voltage) conditions. The PMIC 826 may communicate the information on the battery 824 to the processor circuitry 802 over the IX 806. The PMIC 826 may also include an analog-to-digital(ADC) convertor that allows the processor circuitry 802 to directly monitor the voltage of the battery 824 or the current flow from the battery 824. The battery parameters may be used to determine actions that the compute node 800 may perform, such as transmission frequency, mesh network operation, sensing frequency, and the like.

A power block 828, or other power supply coupled to an electrical grid, may be coupled with the PMIC 826 to charge the battery 824. In some examples, the power block 828 may be replaced with a wireless power receiver to obtain the power wirelessly, for example, through a loop antenna in the compute node 800. In these implementations, a wireless battery charging circuit may be included in the PMIC 826. The specific charging circuits chosen depend on the size of the battery 824, the current required, and/or other conditions/criteria.

The compute node 800 may include any combinations of the components shown by FIG. 8, however, some of the components shown may be omitted, additional components may be present, and/or different arrangement of the components shown may occur in other implementations. In one example where the compute node 800 is or is part of a server computer system, the battery 824, communication circuitry 809, the sensors 821, actuators 822, and/or PoS 845, and possibly some or all of the I/O devices 886 may be omitted. Further, these arrangements can be used in a variety of use cases and/or environments, including those discussed herein (e.g., mobile devices, industrial settings or smart factories, smart cities, military applications, among many other examples).

While specific configurations and arrangements of the the compute node 800 has been described, it should be understood that the compute node 800 can include a variety of additional or alternative components, including any that are not explicitly described herein, and which may be organized, disposed, configured, and/or arranged in a variety of configurations and/or arrangements.

### 2. EXAMPLES

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example A01 includes a method of operating a knowledge-driven data format framework (KDF) processor, the method comprising: generating a format-independent logical structure (FILS) from a source information object (SIO) using a source coder/decoder (codec) associated with a source format of the SIO and according to a source schema that describes a logical structure of the source format.

Example A02 includes the method of example A01 and/or some other example (s) herein, wherein the method includes writing a destination information object (DIO) from the FILS using a destination codec associated with a destination format of the DIO and according to a destination schema that describes a logical structure of the destination format.

Example A03 includes a method of operating a knowledge-driven data format framework (KDF) processor, the method comprising: generating a destination information object (DIO) from a format-independent logical structure (FILS) using a destination source coder/decoder (codec) associated with a destination format of the DIO and according to a destination schema that describes a logical structure of the destination format.

Example A04 includes the method of example A03 and/or some other example (s) herein, wherein the method includes: generating the FILS from a source information object (SIO) using a source codec associated with a source format of the SIO and according to a source schema that describes a logical structure of the source format.

Example A04.5 includes the method of examples A03-A04 and/or some other example (s) herein, wherein the method includes the method of examples A01-A02.

Example A05 includes the method of examples A01-A04.5 and/or some other example (s) herein, wherein the source schema defines logical items that occur in the SIO and the destination schema defines logical items that occur in the DIO.

Example A06 includes the method of examples A01-A05 and/or some other example (s) herein, wherein the KDF processor includes a parser and a serializer, and the method includes: routing an output of the parser to an input of the serializer.

Example A07 includes the method of example A06 and/or some other example (s) herein, wherein the method includes: parsing the SIO into a plurality of data items; and generating the FILS to have an arrangement of the plurality of data items according to a schema format that is independent of the source format.

Example A08 includes the method of examples A06-A067 and/or some other example (s) herein, wherein the method includes: writing the DIO by serializing the plurality of data items from the FILS.

Example A09 includes the method of examples A06-A08 and/or some other example (s) herein, wherein the KDF processor includes a transformer, the schema format is a first schema format, and the method includes: operating the transformer to transform the FILS to have a second arrangement of data items according to a second schema format different than the first schema format.

Example A10 includes the method of example A09 and/or some other example (s) herein, wherein the first schema format and the second schema format are independent of the source format and the destination format.

Example A11 includes the method of examples A06-A10 and/or some other example (s) herein, wherein the source codec includes a plurality of source codec functions, and the method includes: operating the parser to invoke a source codec function of the plurality of source codec functions for each data item of the plurality of data items from the SIO, and write each data item from the SIO to the FILS based on a value returned in response to invocation of the source codec function for each data item; and

Example A12 includes the method of example A11 and/or some other example (s) herein, wherein the method includes: for each data item in the SIO: determining whether a next data item that should occur in the SIO is a mandatory data item or an optional data item according to the source schema; invoking, when the next data item is a mandatory data item, a first source codec function of the plurality of source codec functions to obtain a data value for the mandatory data item; and invoking, when the next data item is an optional data item, a second source codec function of the plurality of source codec functions to determine whether the optional data item did occur or did not occur.

Example A13 includes the method of examples A08-A12 and/or some other example (s) herein, wherein the destination codec includes a plurality of destination codec functions, and the method includes: operating the serializer to invoke a destination codec function of the plurality of destination codec functions for each data item of the plurality of data items from the FILS, and write each data item from the FILS to the DIO based on values returned in response to invocation of the destination codec functions.

Example A14 includes the method of example A13 and/or some other example (s) herein, wherein the method includes: for each data item in the FILS: invoking a first destination codec function of the plurality of codec functions to indicate that zero or more data items did not occur and that a particular data item did occur based on an order of data items defined by the destination schema; and invoking, when a next data item to be written to the DIO is a data item among a set of mutually exclusive data items, a second destination codec function of the plurality of codec functions to indicate that the next data item did occur.

Example A15 includes the method of examples A01-A14 and/or some other example (s) herein, wherein the source schema and the destination schema are among a plurality of schemas, and at least one schema of the plurality of schemas includes one or more annotations, and each annotation of the one or more annotations describes constraints or parameters to be passed to a corresponding codec for one or more encountered events.

Example A16 includes the method of example A15 and/or some other example (s) herein, wherein the one or more annotations include one or more of: an informative annotation to inform the corresponding codec of one or more aspects of a data item that is not discernable from an associated data format; a hidden annotation to inform the corresponding codec about a hidden data item that could occur in the associated data format and is not expressed in the at least one schema; a synthetic annotation to inform the corresponding codec about a synthetic item, the synthetic item being a logical element that could occur in the at least one schema and is not expressed in the associated data format; a conditional annotation to inform the corresponding codec of a conditional data item; and/or a forward reference annotation to inform the corresponding codec of a reference to another data item occurs subsequent in the at least one schema from where the reference occurs in the at least one schema.

Example A17 includes the method of example A16 and/or some other example (s) herein, wherein: the conditional data item is an optional data item and the conditional annotation includes a constraint to be used by the corresponding codec to determine whether the optional data item is present or not, and/or the conditional data item is to be selected from among at least two mutually exclusive data items and the conditional annotation includes a constraint to be used by the corresponding codec to determine how to select a data item from the at least two mutually exclusive data items.

Example A18 includes the method of examples A01-A17 and/or some other example (s) herein, wherein the method includes: receiving the SIO from a source node via a format-independent data-driven (FIDD) application programming interface (API); and sending the DIO to a destination node via the FIDD API.

Example A19 includes the method of example A18 and/or some other example (s) herein, wherein the source node is a first application implemented by the computing system, a virtualization container implemented by the computing system, a virtual machine (VM) implemented by the computing system, a virtualization container implemented by the computing system, a first memory location in the computing system, a first database object, or a first compute node remote from the computing system.

Example A20 includes the method of example A19 and/or some other example (s) herein, wherein the first compute node is a physical computing device, a VM operated by the physical computing device, or a virtualization container operating on the physical computing device.

Example A21 includes the method of examples A19-A20 and/or some other example (s) herein, wherein the destination node is the first application, a second application implemented by the computing system that is different than the first application, the first memory location in the computing system, a second memory location in the computing system, another VM implemented by the computing system, another virtualization container implemented by the computing system, the first compute node, a second database object, or a second compute node remote from the first compute node and the computing system.

Example A22 includes the method of example A21 and/or some other example (s) herein, wherein the physical computing device is a first physical computing device, and the second compute node is a second physical computing device different than the first physical computing device, a VM operated by the second physical computing device, or a virtualization container operating on the second physical computing device.

Example A23 includes the method of examples A01-A22 and/or some other example (s) herein, wherein the destination format is different than the source format.

Example A24 includes the method of examples A01-A23 and/or some other example (s) herein, wherein the destination format is a same format as the source format.

Example A25 includes the method of examples A01-A24 and/or some other example (s) herein, wherein the KDF processor is implemented in or part of an Internet of Things(IoT) device, a user computing system, a vehicle computing system, a marine computing system, an aerial computing system, a satellite computing system, a service provider system, a network access node, or a gateway device.

Example Z01 includes one or more computer readable media comprising instructions, wherein execution of the instructions by processor circuitry is to cause the processor circuitry to perform the method of any one or more of examples A01-A25 and/or some other example (s) discussed herein.

Example Z02 includes a computer program comprising the instructions of example Z01.

Example Z03 includes an Application Programming Interface (API) defining functions, methods, variables, data structures, and/or protocols for the computer program of example Z02 and/or some other example (s) discussed herein.

Example Z04 includes an API or specification defining functions, methods, variables, data structures, protocols, and the like, defining or involving use of any of examples A01-A25, portions thereof, or otherwise related to any of examples A01-A25 and/or some other example (s) discussed herein.

Example Z05 includes an apparatus comprising circuitry loaded with the instructions of example Z01 and/or some other example (s) discussed herein.

Example Z06 includes an apparatus comprising circuitry operable to run the instructions of example Z01 and/or some other example (s) discussed herein.

Example Z07 includes an integrated circuit comprising one or more of the processor circuitry and the one or more computer readable media of example Z01 and/or some other example (s) discussed herein.

Example Z08 includes a computing system comprising the one or more computer readable media and the processor circuitry of example Z01 and/or some other example (s) discussed herein.

Example Z09 includes an apparatus comprising means for executing the instructions of example Z01 and/or some other example (s) discussed herein.

Example Z10 includes a signal generated as a result of executing the instructions of example Z01 and/or some other example (s) discussed herein.

Example Z11 includes a data unit generated as a result of executing the instructions of example Z01 and/or some other example (s) discussed herein.

Example Z12 includes the data unit of example Z10 and/or some other example (s) herein, wherein the data unit is a datagram, packet, frame, data segment, Protocol Data Unit(PDU), Service Data Unit(SDU), message, type length value (TLV), segment, block, cell, chunk, or database object.

Example Z13 includes a signal encoded with the data unit of examples Z11 and/or Z12 and/or some other example (s) discussed herein.

Example Z14 includes an electromagnetic signal carrying the instructions of example Z01 and/or some other example (s) discussed herein.

Example Z15 includes an apparatus comprising means for performing the method of examples A01-A25 and/or some other example (s) herein.

Example Z16 includes virtualization infrastructure including one or more hardware elements on which services and/or applications related to the method of examples A01-A25, portions thereof, and/or some other example (s) herein, is to operate, execute or run.

Example Z17 includes an edge compute node configured to execute and/or operate a service as part of one or more edge applications instantiated on the virtualization infrastructure of example Z16 and/or some other example (s) herein, wherein the service is related to the method of examples A01-A25, portions thereof, and/or some other example (s) herein.

Example Z18 includes a cloud computing service including or operating on a set of cloud compute nodes, wherein a subset of the set of cloud compute nodes is/are configured to execute and/or operate a service as part of one or more cloud applications, wherein the service is related to the method of examples A01-A25, portions thereof, and/or some other example (s) herein.

Example Z19 includes the cloud computing service of example Z18 and/or some other examples herein, wherein the set of cloud compute nodes includes, or is part of, the virtualization infrastructure of example Z16 and/or some other example (s) herein.

### 3. TERMINOLOGY

In the preceding detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the following terms and definitions, as well as the terms and definitions discussed in [′295], are applicable to the examples and embodiments discussed herein. . . . As used herein, the singular forms “a,” “an” and “the” are intended to include plural forms as well, unless the context clearly indicates otherwise. The phrase “A and/or B” means(A), (B), or(A and B). For the purposes of the present disclosure, the phrase “A, B, and/or C” means(A), (B), (C), (A and B), (A and C), (B and C), or(A, B and C). The phrase “X(s)” means one or more X or a set of X. The description may use the phrases “in an embodiment,” “In some embodiments,” “in one implementation,” “In some implementations,” “in some examples”, and the like, each of which may refer to one or more of the same or different embodiments, implementations, and/or examples. The terms “comprises” and/or “comprising,” when used herein, specify the presence of stated features, integers, steps, operations, elements, and/or components, but do not preclude the presence or addition of one or more other features, integers, steps, operation, elements, components, and/or groups thereof. Furthermore, the terms “comprising,” “including,” “having,” and the like, as used with respect to the present disclosure, are synonymous. Where the disclosure recites “a” or “a first” element or the equivalent thereof, such disclosure includes one or more such elements, neither requiring nor excluding two or more such elements. Further, ordinal indicators(e.g., first, second or third) for identified elements are used to distinguish between the elements, and do not indicate or imply a required or limited number of such elements, nor do they indicate a particular position or order of such elements unless otherwise specifically stated.

The term “element” at least in some examples refers to a unit that is indivisible at a given level of abstraction and has a clearly defined boundary, wherein an element may be any type of entity including, for example, one or more devices, systems, controllers, schedulers, network elements, modules, engines, functions, components, and so forth, or any combination(s) thereof. The term “entity” at least in some examples refers to a distinct element of a component, architecture, platform, device, system, controller, scheduler, function, engine, and/or other element(s). Additionally or alternatively, the term “entity” at least in some examples refers to information transferred as a payload.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel, link, and/or the like.

The term “circuitry” at least in some examples refers to a circuit or system of multiple circuits configured to perform a particular function in an electronic device. The circuit or system of circuits may be part of, or include one or more hardware components, such as a logic circuit, a processor(shared, dedicated, or group) and/or memory(shared, dedicated, or group), an application-specific integrated circuit(ASIC), field-programmable gate array(FPGA), programmable logic controller (PLC), single-board computer (SBC), system on chip(SoC), system in package (SiP), multi-chip package (MCP), digital signal processor(DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” at least in some examples refers to, is part of, or includes circuitry capable of sequentially and automatically carrying out a sequence of arithmetic or logical operations, or recording, storing, and/or transferring digital data. The term “processor circuitry” at least in some examples refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” at least in some examples refers to one or more hardware devices for storing data, including random access memory(RAM), static RAM (SRAM), dynamic RAM(DRAM), synchronous DRAM(SDRAM), magnetoresistive RAM(MRAM), conductive bridge Random Access Memory(CB-RAM), spin transfer torque (STT)-MRAM, phase change RAM(PRAM), core memory, read-only memory(ROM), programmable ROM(PROM), erasable PROM(EPROM), electrically EPROM(EEPROM), flash memory, non-volatile RAM (NVRAM), magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “computer system” at least in some examples refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “architecture” at least in some examples refers to a computer architecture or a network architecture. A “network architecture” is a physical and logical design or arrangement of software and/or hardware elements in a network including communication protocols, interfaces, and media transmission. A “computer architecture” is a physical and logical design or arrangement of software and/or hardware elements in a computing system or platform including technology standards for interacts therebetween.

The term “appliance,” “computer appliance,” or the like, at least in some examples refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “gateway” at least in some examples refers to networking hardware and/or software elements that allow(s) data to flow between different networks, compute nodes, and/or processes. Additionally or alternatively, term “gateway” at least in some examples refers to a computing device, system, and/or application configured to perform the tasks of a gateway. Additionally or alternatively, term “gateway” at least in some examples refers to a software and/or hardware element that translates data between two or more nodes on the same or different networks. Additionally or alternatively, term “gateway” at least in some examples refers to a software and/or hardware element that translates data between two or more processes on the same or different machines. Examples of gateways may include IP gateways, Internet-to-Orbit (120) gateways, IoT gateways, cloud storage gateways, Tactical Data Link(TDL) gateways, and/or the like.

The term “device” at least in some examples refers to a physical entity embedded inside, or attached to, another physical entity in its vicinity, with capabilities to convey digital information from or to that physical entity. The term “controller” at least in some examples refers to an element or entity that has the capability to affect a physical entity, such as by changing its state or causing the physical entity to move. The term “scheduler” at least in some examples refers to an entity or element that assigns resources (e.g., processor time, network links, memory space, and/or the like) to perform tasks.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like. For purposes of the present disclosure, the term “node” at least in some examples refers to and/or is interchangeable with the terms “device”, “component”, “sub-system”, and/or the like.

The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources. Furthermore, the term “computer system” and/or “system” may refer to multiple computer devices and/or multiple computing systems that are communicatively coupled with one another and configured to share computing and/or networking resources. Additionally, the terms “computer system” may be considered synonymous to, and may hereafter be occasionally referred to, as a computer device, computing device, computing platform, client device, client, mobile, mobile device, user equipment(UE), terminal, receiver, server, and/or the like, and may describe any physical hardware device capable of sequentially and automatically carrying out a sequence of arithmetic or logical operations; equipped to record/store data on a machine readable medium; and transmit and receive data from one or more other devices in a communications network. The term “computer system” may include any type of electronic devices, such as a cellular phone or smart phone, tablet personal computer, wearable computing device, an autonomous sensor, laptop computer, desktop personal computer, a video game console, a digital media player, a handheld messaging device, a personal data assistant, an electronic book reader, an augmented reality device, server computer device (s) (e.g., stand-alone, rack-mounted, blade, and/or the like), and/or any other like electronic device.

The term “server” at least in some examples refers to a computing device or system, including processing hardware and/or process space (s), an associated storage medium such as a memory device or database, and, in some instances, suitable application(s) as is known in the art. The terms “server system” and “server” may be used interchangeably herein, and these terms at least in some examples refers to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers may include an operating system(OS) that provides executable program instructions for the general administration and operation of the individual server computer devices, and may include a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “compute resource” or simply “resource” at least in some examples refers to an object with a type, associated data, a set of methods that operate on it, and, if applicable, relationships to other resources. Additionally or alternatively, the term “compute resource” or “resource” at least in some examples refers to any physical or virtual component, or usage of such components, of limited availability within a computer system or network. Examples of computing resources include usage/access to, for a period of time, servers, processor(s), storage equipment, memory devices, memory areas, networks, electrical power, input/output(peripheral) devices, mechanical devices, network connections(e.g., channels/links, ports, network sockets, and the like), operating systems, virtual machines (VMs), software/applications, computer files, and/or the like. A “hardware resource” at least in some examples refers to compute, storage, and/or network resources provided by physical hardware element(s). A “virtualized resource” at least in some examples refers to compute, storage, and/or network resources provided by virtualization infrastructure to an application, device, system, and the like. The term “network resource” or “communication resource” at least in some examples refers to resources that are accessible by computer devices/systems via a communications network. The term “system resources” at least in some examples refers to any kind of shared entities to provide services, and may include computing and/or network resources. In some examples, system resources may be considered as a set of coherent functions, network data objects or services, accessible through a server where such system resources reside on a single host or multiple hosts and are clearly identifiable.

The term “virtualization container”, “execution container”, or “container” at least in some examples refers to a partition of a compute node that provides an isolated virtualized computation environment. The term “OS container” at least in some examples refers to a virtualization container utilizing a shared Operating System(OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings.

The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces). The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In some examples, a “protocol” and/or a “communication protocol” may be represented using a protocol stack, a finite state machine (FSM), and/or any other suitable data structure.

The term “access technology” at least in some examples refers to the technology used for the underlying physical connection to a communication network. The term “radio access technology” or “RAT” at least in some examples refers to the technology used for the underlying physical connection to a radio based communication network. Examples of access technologies include wireless access technologies/RATs, wireline, wireline-cable, wireline broadband forum (wireline-BBF), Ethernet, TimeTriggered Ethernet(TTE), air-based Ethernet or air-to-air Ethernet, Aircraft Data Network (ADN) and/or Avionics Full-Duplex Switched Ethernet(AFDX) defined by ARINC 664, controller-pilot data link communications(CPDLC) and/or controller pilot data link (CPDL)(e.g., FANS-1/A, ICAO Doc 9705 compliant ATN/CPDLC systems, and/or the like), Aircraft Communications Addressing and Reporting System(ACARS)(e.g., ARINC 618, ARINC 633, ARINC 724B, and/or the like), fiber optics networks(e.g., ITU-T G.651, ITU-T G.652, Optical Transport Network (OTN), Synchronous optical networking (SONET) and synchronous digital hierarchy(SDH), and the like), digital subscriber line (DSL) and variants thereof, Data Over Cable Service Interface Specification(DOCSIS) technologies, hybrid fiber-coaxial(HFC) technologies, and/or the like. Examples of RATs(or RAT types) and/or communications protocols include Advanced Mobile Phone System(AMPS) technologies (e.g., Digital AMPS(D-AMPS), Total Access Communication System(TACS) and variants thereof, such as Extended TACS(ETACS), and the like); Global System for Mobile Communications(GSM) technologies (e.g., Circuit Switched Data(CSD), High-Speed CSD(HSCSD), General Packet Radio Service (GPRS), and Enhanced Data Rates for GSM Evolution(EDGE)); Third Generation Partnership Project (3GPP) technologies (e.g., Universal Mobile Telecommunications System(UMTS) and variants thereof (e.g., UMTS Terrestrial Radio Access(UTRA), Wideband Code Division Multiple Access(W-CDMA), Freedom of Multimedia Access(FOMA), Time Division-Code Division Multiple Access (TD-CDMA), Time Division-Synchronous Code Division Multiple Access(TD-SCDMA), and the like), Generic Access Network (GAN)/Unlicensed Mobile Access(UMA), High Speed Packet Access(HSPA) and variants thereof(e.g., HSPA Plus(HSPA+)), Long Term Evolution(LTE) and variants thereof(e.g., LTE-Advanced(LTE-A), Evolved UTRA(E-UTRA), LTE Extra, LTE-A Pro, LTE LAA, MuLTEfire, and the like), Fifth Generation(5G) or New Radio(NR), narrowband IoT (NB-IoT), 3GPP Proximity Services (ProSe), and/or the like); ETSI RATs(e.g., High Performance Radio Metropolitan Area Network (HiperMAN), Intelligent Transport Systems(ITS)(e.g., ITS-G5, ITS-G5B, ITS-G5C, and the like), and the like); Institute of Electrical and Electronics Engineers (IEEE) technologies and/or WiFi(see e.g., IEEE Standard for Local and Metropolitan Area Networks: Overview and Architecture, IEEE Std 802-2014, pp. 1-74 (30 Jun. 2014), and IEEE Standard for Information Technology—Telecommunications and Information Exchange between Systems-Local and Metropolitan Area Networks—Specific Requirements-Part 11: Wireless LAN Medium Access Control(MAC) and Physical Layer (PHY) Specifications, IEEE Std 802.11-2020, pp. 1-4379 (26 Feb. 2021), IEEE 802.15 technologies and variants thereof(e.g., ZigBee, WirelessHART, MiWi, ISA100.11a, Thread, IPv6 over Low power WPAN(6LoWPAN), and the like), IEEE Std 802.15.6-2012, and the like), V2X(e.g., IEEE 1609.0-2019, IEEE 802.11bd, Dedicated Short Range Communications(DSRC), and/or the like), Worldwide Interoperability for Microwave Access(WiMAX), Mobile Broadband Wireless Access(MBWA)/iBurst, Wireless Gigabit Alliance (WiGig)(e.g., IEEE 802.11ad, IEEE 802.11ay, and the like), and so forth); Integrated Digital Enhanced Network (iDEN) and variants thereof(e.g., Wideband Integrated Digital Enhanced Network (WIDEN)); millimeter wave (mmWave) technologies/standards(e.g., wireless systems operating at 10-300 GHz and above 3GPP 5G); short-range and/or wireless personal area network (WPAN) technologies/standards(e.g., IEEE 802.15 technologies (e.g., as mentioned previously); Bluetooth and variants thereof(e.g., Bluetooth 5.3, Bluetooth Low Energy (BLE), and the like), WiFi-direct, Miracast, ANT/ANT+, Z-Wave, Universal Plug and Play(UPnP), low power Wide Area Networks(LPWANs), Long Range Wide Area Network (LoRA or LoRaWAN™), and the like); optical and/or visible light communication(VLC) technologies/standards; Sigfox; Mobitex; 3GPP2 technologies (e.g., cdmaOne (2G), Code Division Multiple Access 2000 (CDMA 2000), and Evolution-Data Optimized or Evolution-Data Only(EV-DO); Push-to-talk(PTT), Mobile Telephone System(MTS) and variants thereof(e.g., Improved MTS(IMTS), Advanced MTS(AMTS), and the like); Personal Digital Cellular(PDC); Personal Handy-phone System(PHS), Cellular Digital Packet Data(CDPD); Cellular Digital Packet Data(CDPD); DataTAC; Digital Enhanced Cordless Telecommunications(DECT) and variants thereof(e.g., DECT Ultra Low Energy(DECT ULE), DECT-2020, DECT-5G, and the like); Ultra High Frequency(UHF) communication; Very High Frequency(VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union(ITU), or the ETSI, among others. The examples provided herein are thus understood as being applicable to various other communication technologies, both existing and not yet formulated.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “stack” at least in some examples refers to an abstract data type that serves as a collection of elements and may include a push operation or function, a pop operation or function, and sometimes a peek operation or function. The term “push”, in the context of data structures such as stacks, buffers, and queues, at least in some examples refers an operation or function that adds one or more elements to a collection or set of elements. The term “pop”, in the context of data structures such as stacks, buffers, and queues, at least in some examples refers an operation or function that removes or otherwise obtains one or more elements from a collection or set of elements. The term “peek”, in the context of data structures such as stacks, buffers, and queues, at least in some examples refers an operation or function that provides access to one or more elements from a collection or set of elements.

The term “application” or “app” at least in some examples refers to a computer program designed to carry out a specific task other than one relating to the operation of the computer itself. Additionally or alternatively, term “application” or “app” at least in some examples refers to a complete and deployable package, environment to achieve a certain function in an operational environment.

The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. In some examples, an API may be defined or otherwise used for a web-based system, operating system, database system, computer hardware, software library, and/or the like.

The term “process” at least in some examples refers to an instance of a computer program that is being executed by one or more threads. In some implementations, a process may be made up of multiple threads of execution that execute instructions concurrently.

The term “data processing” or “processing” at least in some examples refers to any operation or set of operations which is performed on data or on sets of data, whether or not by automated means. In some examples, “data processing” or “processing” includes collection, recording, writing, organization, structuring, storing, adaptation, alteration, retrieval, consultation, use, disclosure by transmission, dissemination or otherwise making available, alignment or combination, restriction, erasure and/or destruction. The term “data preprocessing” or “data pre-processing” at least in some examples refers to any operation or set of operations performed prior to data processing including, for example, data manipulation, dropping of data items/points, and/or the like.

The term “software engine” at least in some examples refers to a component of a software system, subsystem, component, functional unit, module or other collection of software elements, functions, and the like. In some examples, the term “software engine” can be used interchangeably with the terms “software core engine” or simply “engine”. The term “software component” at least in some examples refers to a software package, web service, web resource, module, application, algorithm, and/or another collection of elements, or combination(s) therefore, that encapsulates a set of related functions(or data).

The terms “instantiate,” “instantiation,” and the like at least in some examples refers to the creation of an instance. In some examples, an “instance” refers to a concrete occurrence of an object, which may occur, for example, during execution of program code.

The terms “configuration”, “policy”, “ruleset”, and/or “operational parameters”, at least in some examples refer to a machine-readable information object or other data structure that contains instructions, conditions, parameters, and/or criteria that are relevant to a device, system, component, and/or other element(s).

The term “database object” at least in some examples refers to any representation of information that is in the form of an object, attribute-value pair(AVP), key-value pair(KVP), tuple, and/or the like, and may include variables, data structures, functions, methods, classes, database records, database fields, database entities, associations between data and/or database entities (also referred to as a “relation”), blocks in block chain implementations, and/or links between blocks in block chain implementations. In some examples, a database object may include a number of records, and each record may include a set of fields. In some examples, a database object can be unstructured or have a structure defined by a database management system (DBMS) and/or defined by a user (e.g., a custom database object). In some implementations, a record may take different forms based on the database model being used and/or the specific database object to which it belongs. In some examples, a record may be a row in a table of a relational database, a JavaScript Object Notation(JSON) object, an XML document and/or XML element, a KVP, and/or the like.

The term “data set” or “dataset” at least in some examples refers to a collection of data; a “data set” or “dataset” may be formed or arranged in any type of data structure. In some examples, one or more characteristics can define or influence the structure and/or properties of a dataset such as the number and types of attributes and/or variables, and various statistical measures (e.g., standard deviation, kurtosis, and/or the like).

The term “data structure” at least in some examples refers to a data organization, management, and/or storage format. Additionally or alternatively, the term “data structure” at least in some examples refers to a collection of data values, the relationships among those data values, and/or the functions, operations, tasks, and the like, that can be applied to the data. Examples of data structures include primitives (e.g., Boolean, character, floating-point numbers, fixed-point numbers, integers, reference or pointers, enumerated type, and/or the like), composites (e.g., arrays, records, strings, union, tagged union, and/or the like), abstract data types (e.g., data container, list, tuple, associative array, map, dictionary, set(or dataset), multiset or bag, stack, queue, graph (e.g., tree, heap, and the like), and/or the like), routing table, symbol table, quad-edge, blockchain, purely-functional data structures (e.g., stack, queue, (multi) set, random access list, hash consing, zipper data structure, and/or the like)

The term “information object” or “InOb” at least in some examples refers to a data structure or piece of information, definition, or specification that includes a name to identify its use in an instance of communication. Additionally or alternatively, the term “information object” or “InOb” at least in some examples refers to a configuration item that displays information in an organized form. Additionally or alternatively, the term “information object” or “InOb” at least in some examples refers to an abstraction of a real information entity and/or a representation and/or an occurrence of a real-world entity. Additionally or alternatively, the term “information object” or “InOb” at least in some examples refers to a data structure that contains and/or conveys information or data. Examples of “information objects” include electronic documents, database objects, data files, resources, webpages, web forms, applications(e.g., desktop apps, native apps, web apps, mobile apps, hybrid apps, and so forth), services, microservices, web services, media, or content, and/or the like. In some examples, information objects may be stored and/or processed according to a suitable data format. Examples of the data formats that may be used for any of the InObs discussed herein can include any of those discussed herein, any of those discussed in [′295], and/or those not explicitly described herein. The term “electronic document” or “document” at least in some examples refers to a computer file or resource used to record data, and includes various file types or formats such as word processing, spreadsheet, slide presentation, multimedia items, and the like.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

1-44. (canceled)

45. A method of operating a knowledge-driven data format framework (KDF) processor, the method comprising:
generating a format-independent logical structure (FILS) from a source information object (SIO) using a source coder/decoder (codec) associated with a source format of the SIO and according to a source schema that describes a logical structure of the source format; and
generating a destination information object (DIO) from the FILS using a destination source coder/decoder (codec) associated with a destination format of the DIO and according to a destination schema that describes a logical structure of the destination format.

46. The method of claim 45, wherein the source schema defines logical items that occur in the SIO and the destination schema defines logical items that occur in the DIO.

47. The method of claim 45, wherein the KDF processor includes a parser and a serializer, and the method includes: routing an output of the parser to an input of the serializer.

48. The method of claim 47, wherein the method includes: parsing the SIO into a plurality of data items; and generating the FILS to have an arrangement of the plurality of data items according to a schema format that is independent of the source format.

49. The method of claim 48, wherein the method includes: writing the DIO by serializing the plurality of data items from the FILS.

50. The method of claim 47, wherein the KDF processor includes a transformer, the schema format is a first schema format, and the method includes: operating the transformer to transform the FILS to have a second arrangement of data items according to a second schema format different than the first schema format.

51. The method of claim 50, wherein the first schema format and the second schema format are independent of the source format and the destination format.

52. The method of claim 47, wherein the source codec includes a plurality of source codec functions, and the method includes: operating the parser to invoke a source codec function of the plurality of source codec functions for each data item of the plurality of data items from the SIO, and write each data item from the SIO to the FILS based on a value returned in response to invocation of the source codec function for each data item.

53. The method of claim 52, wherein the method includes: for each data item in the SIO:
determining whether a next data item that should occur in the SIO is a mandatory data item or an optional data item according to the source schema;
invoking, when the next data item is a mandatory data item, a first source codec function of the plurality of source codec functions to obtain a data value for the mandatory data item; and
invoking, when the next data item is an optional data item, a second source codec function of the plurality of source codec functions to determine whether the optional data item did occur or did not occur.

54. The method of claim 49, wherein the destination codec includes a plurality of destination codec functions, and the method includes: operating the serializer to invoke a destination codec function of the plurality of destination codec functions for each data item of the plurality of data items from the FILS, and write each data item from the FILS to the DIO based on values returned in response to invocation of the destination codec functions.

55. The method of claim 54, wherein the method includes: for each data item in the FILS:
invoking a first destination codec function of the plurality of codec functions to indicate that zero or more data items did not occur and that a particular data item did occur based on an order of data items defined by the destination schema; and
invoking, when a next data item to be written to the DIO is a data item among a set of mutually exclusive data items, a second destination codec function of the plurality of codec functions to indicate that the next data item did occur.

56. The method of claim 45, wherein the source schema and the destination schema are among a plurality of schemas, and at least one schema of the plurality of schemas includes one or more annotations, and each annotation of the one or more annotations describes constraints or parameters to be passed to a corresponding codec for one or more encountered events.

57. The method of claim 56, wherein the one or more annotations include one or more of:
an informative annotation to inform the corresponding codec of one or more aspects of a data item that is not discernable from an associated data format;
a hidden annotation to inform the corresponding codec about a hidden data item that could occur in the associated data format and is not expressed in the at least one schema;
a synthetic annotation to inform the corresponding codec about a synthetic item, the synthetic item being a logical element that could occur in the at least one schema and is not expressed in the associated data format;
a conditional annotation to inform the corresponding codec of a conditional data item; or
a forward reference annotation to inform the corresponding codec of a reference to another data item occurs subsequent in the at least one schema from where the reference occurs in the at least one schema.

58. The method of claim 57, wherein: the conditional data item is an optional data item and the conditional annotation includes a constraint to be used by the corresponding codec to determine whether the optional data item is present or not, and/or the conditional data item is to be selected from among at least two mutually exclusive data items and the conditional annotation includes a constraint to be used by the corresponding codec to determine how to select a data item from the at least two mutually exclusive data items.

59. The method of claim 45, wherein the method includes: receiving the SIO from a source node via a format-independent data-driven (FIDD) application programming interface (API); and sending the DIO to a destination node via the FIDD API.

60. The method of claim 59, wherein the source node is a first application implemented by a computing system, a virtualization container implemented by the computing system, a virtual machine (VM) implemented by the computing system, a virtualization container implemented by the computing system, a first memory location in the computing system, a first database object, or a first compute node remote from the computing system.

61. The method of claim 60, wherein the first compute node is a physical computing device, a VM operated by the physical computing device, or a virtualization container operating on the physical computing device.

62. The method of claim 60, wherein the destination node is the first application, a second application implemented by the computing system that is different than the first application, the first memory location in the computing system, a second memory location in the computing system, another VM implemented by the computing system, another virtualization container implemented by the computing system, the first compute node, a second database object, or a second compute node remote from the first compute node and the computing system.

63. The method of claim 62, wherein the physical computing device is a first physical computing device, and the second compute node is a second physical computing device different than the first physical computing device, a VM operated by the second physical computing device, or a virtualization container operating on the second physical computing device.

64. The method of claim 45, wherein the destination format is different than the source format.

65. The method of claim 45, wherein the destination format is a same format as the source format.

66. The method of claim 45, wherein the KDF processor is implemented in or part of an Internet of Things(IoT) device, a user computing system, a vehicle computing system, a marine computing system, an aerial computing system, a satellite computing system, a service provider system, a network access node, or a gateway device.

67. A system for operating a knowledge-driven data format framework (KDF) processor, comprising:
a memory;
a processor coupled to the memory; and
a software component executed by the processor that is configured to:
generate a format-independent logical structure (FILS) from a source information object (SIO) using a source coder/decoder (codec) associated with a source format of the SIO and according to a source schema that describes a logical structure of the source format; and
generate a destination information object (DIO) from the FILS using a destination source coder/decoder (codec) associated with a destination format of the DIO and according to a destination schema that describes a logical structure of the destination format.

68. The system of claim 67, wherein the source schema defines logical items that occur in the SIO and the destination schema defines logical items that occur in the DIO.

69. The system of claim 67, wherein the KDF processor includes a parser and a serializer, and the software component is further configured to route an output of the parser to an input of the serializer.
